(19) United States
(12) Patent Application Publication
(10) Pub. No.: US 2020/0356811 A1
(43) Pub. Date: Nov. 12, 2020

(54) Computer Vision Systems and Methods for Machine Learning Using a Set Packing Framework

(71) Applicant: Insurance Services Office, Inc., Jersey City, NJ (US)

(72) Inventors: Julian Yarkony, Jersey City, NJ (US); Yossiri Adulyasak, Montreal (CA); Maneesh Kumar Singh, Lawrenceville, NJ (US); Guy Desaulniers, Blainville (CA)

(73) Assignee: Insurance Services Office, Inc., Jersey City, NJ (US)

(21) Appl. No.: 16/870,492

(22) Filed: May 8, 2020

Related U.S. Application Data
(60) Provisional application No. 62/845,526, filed on May 9, 2019.

(51) Int. Cl. G06K 9/62; G06K 9/00; G06T 7/62; G06T 7/00; G06N 20/00; G06N 5/04

(52) U.S. Cl. CPC G06K 9/6256; G06K 9/6218; G06K 9/00362; G06K 9/00711; G06K 9/0014; G06T 2207/20084; G06T 7/0012; G06K 9/6261; G06N 20/00; G06N 5/04; G06T 2207/20081; G06T 7/62

(57) ABSTRACT

Computer vision systems and methods for machine learning using a set packing framework are provided. A minimum weight set packing (“MWSP”) framework is parameterized by a set of possible hypotheses, each of which is associated with a real valued cost that describes the sensibility of the belief that the members of the hypothesis correspond to a common cause. Using MWSP, the system then selects the lowest total cost set of hypotheses, such that no two selected hypotheses share a common observation. Observations that are not included in any selected hypothesis, define the set of false observations can be thought of as false observations/noise. The system can be utilized to support one or more trained computer models in performing computer vision on input data in order to generate output data.

### RELATED APPLICATIONS

The present application claims the benefit of U.S. Provisional Patent Application Ser. No. 62/845,526 filed on May 9, 2019, the entire disclosure of which is expressly incorporated herein by reference.

### BACKGROUND

### Technical Field

The present disclosure relates generally to the field of computer vision technology. More specifically, the present disclosure relates to computer vision systems and methods for machine learning using a set packing framework.

### RELATED ART

Artificial neural networks (“ANN”) excel at learning functions that map input data vectors (e.g., images of objects such as a dog, a cat, a horse, etc.) to output labels (e.g., semantic label: dog, cat, horse, etc.) by using large quantities of labeled training data. An ANN learns a function that generalizes beyond a training data set to produce the correct label as output on test data not part of the training data set. A possible application of ANNs is object recognition, in which an ANN learns to recognize the presence of objects (e.g., cat, dog, horse, etc.) in images. Large data sets facilitate learning such functions. An example of a large data set includes the image-net data set, which provides fourteen million training images, each associated with the labels of the objects present in the image.

Localizing each unique instance of objects in crowded images, which is called instance segmentation, is an important related task to object recognition. The common approach to instance segmentation iterates over all possible rectangles of pixels (called bounding boxes) in the image, and predicts the presence of each object in that rectangle. However, combining the hypotheses generated in each rectangle to describe each unique instance of objects is challenging as the hypotheses need not be mutually consistent. For example, multiple predicted hypotheses can share a common pixel, but multiple objects cannot be associated with the same pixel in the ground truth. Heuristics, such as non-max suppression, are often used to remove conflicts between predicted hypotheses. Non-max suppression removes from consideration all but one of each set of “similar” and/or overlapping predictions. Combinatorial optimization provides a principled alternative to non-max suppression heuristics, which is referred to as data association.

Data association uses combinatorial optimization to partition the observations in a data set (e.g., pixels in an image) into a set of hypotheses (e.g., unique instances of objects or background), each associated with a subset of the observations that are consistent with the statistical properties of the known structure of hypothesis.

The use of combinatorial optimization in computer vision/machine learning, has developed largely without influence from the operations research community, and has been focused on network flows (called graph cuts), primal dual methods (the most prominent of which is message passing), and compact linear programming (“LP”) relaxations augmented with cutting plane methods. This often leads to less efficient/optimal solvers than are desirable. Further, the capacity of the associated models is limited by not taking advantage of the decades of research in combinatorial optimization in the operations research community.

Recently the core operations research techniques of column generation (“CG”) and (nested) Benders decomposition (called “(N)BD”) have been introduced to the machine learning and computer vision communities. However, the application of these techniques, and the construction of models to support the use of CG and (N)BD is in its infancy.

Therefore, there is a need for computer vision systems and methods which can he overcome data association problems in computer visions systems, thereby improving the speed and efficiency of the computer vision systems. These and other needs are addressed by the computer vision systems and methods of the present disclosure.

### SUMMARY

The present disclosure relates to computer vision systems and methods for machine learning using a set packing framework. The systems and methods disclosed herein include a minimum weight set packing (“MWSP”) framework, which uses advance methods of integer programming that the system applies to data association problems commonly studied in computer vision. In the present system, an MWSP instance for data association is parameterized by a set of possible hypotheses, each of which is associated with a real valued cost, that describes the sensibility of the belief that the members of the hypothesis correspond to a common cause. Using MWSP, the system then selects the lowest total cost set of hypotheses, such that no two selected hypotheses share a common observation. Observations that are not included in any selected hypothesis, define the set of false observations can be thought of as false observations/noise. Embodiments and examples of the present disclosure will be discussed in regards to multi-person detection, which can be used in, for example, self-driving car applications. The set of observations is the set of all pixels, and the set of possible hypotheses is the power set of pixels. The statistical support for a hypothesis, is defined in terms of how well a classifier (such as an ANN) scores the quality of a single person dominating the corresponding pixels.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating overall system of the present disclosure;

FIG. 2 is a flowchart illustrating overall process steps carried out by the system of the present disclosure;

FIG. 3 is an illustration of an algorithm for column generation in connection with step 36, as described in connection with FIG. 2;

FIG. 4 is a flowchart illustrating process steps being carried out by the system of the present disclosure to generate a minimum weight set packing (“MWSP”) formulation of multi-person tracking;

FIGS. 5A-5C are a set of images showing multi-object tracking in connection with the system of the present disclosure;

FIG. 6 is a flowchart illustrating process steps being carried out by the system of the present disclosure to generate a multi-person tracking MWSP formulation for data association;

FIG. 7 is an illustration showing subtracks in connection with step 72 of FIG. 6;

FIG. 8 is a flowchart illustrating process steps being carried out by the system of the present disclosure to generate a MWSP formulation of multi-person pose estimation (“MPPE”);

FIG. 9 is an image showing multi-person pose estimation in connection with the system of the present disclosure;

FIGS. 10A-B are illustrations showing a tree model of the present disclosure, augmented with additional connections, where additional connections trade off optimization difficulty and modeling power;

FIG. 11 is a flowchart illustrating process steps being carried out by the system of the present disclosure to generate a MPPE MWSP formulation for data association;

FIG. 12 is a flowchart illustrating process steps being carried out by the system of the present disclosure to generate multi-cell segmentation;

FIG. 13 is an image showing a multi-cell instance segmentation in connection with FIG. 12;

FIG. 14 is a flowchart illustrating process steps being carried out by the system of the present disclosure to generate a MWSP formulation of multi-cell segmentation;

FIG. 15 is a flowchart illustrating process steps being carried out by the system of the present disclosure to tighten the linear program relaxation of the MWSP;

FIG. 16 is an algorithm describing the column/row generation (“CRG”) in connection with the present disclosure;

FIG. 17 is a table showing splits enumerated for a triplet of observations in connection with the present disclosure;

FIG. 18 is a set of images illustrating a qualitative example of improvement as a result of increasing subtrack length;

FIGS. 19A-B are graphs showing a comparison of timing/cost performance of the present disclosure with a baseline dual decomposition approach;

FIG. 20 shows a table comparing column generation against a prior art heuristic optimization procedure in terms of the accuracy (average precision) on standard computer vision benchmarks;

FIG. 21 is a set of images showing sample outputs of the system of the present disclosure;

FIG. 22 is a table showing a comparison in total time in second and comparative speed up using dual optimal inequalities (“DOI”) on different solvers;

FIGS. 23-24 are scatter plots showing time consumed using DOI for each of the two solvers;

FIG. 25 is an illustration showing an output of the present system;

FIG. 26 is a graph showing the results of the comparison between the present system and prior art systems;

FIG. 27 is a graph showing optimization time for column generation across problem instances in dataset one; and

FIG. 28 is a diagram illustrating sample hardware and software components capable of being used to implement the system of the present disclosure.

### DETAILED DESCRIPTION

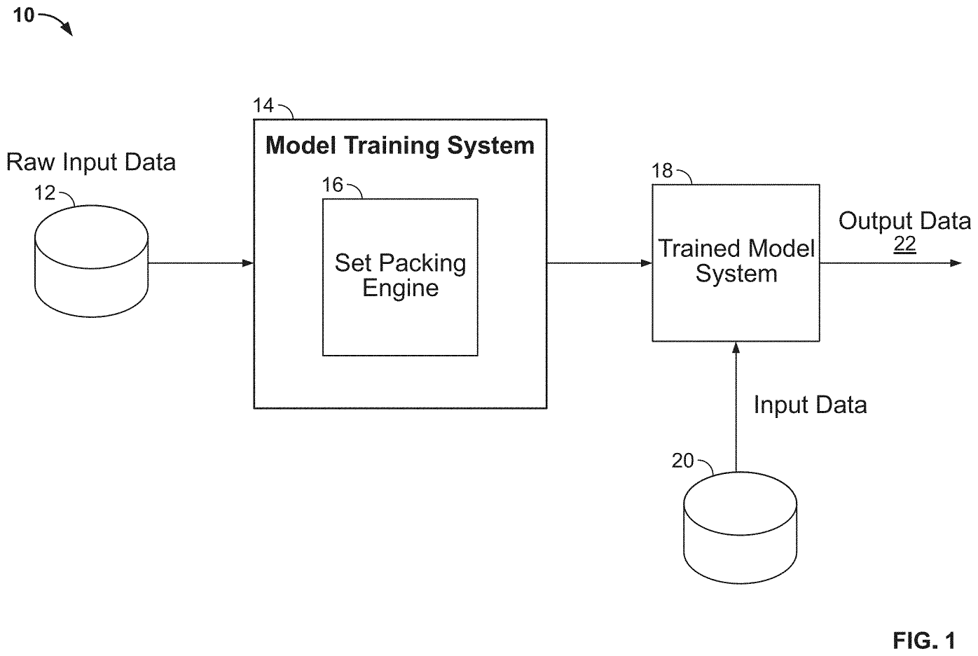

The present disclosure relates to computer vision systems and methods for machine learning using a set packing framework, as described in detail below in connection with FIGS. 1-28.

FIG. 1 is a diagram illustrating the system of the present disclosure, indicated generally at 10. The system 10 includes a model training system 14 which receives raw input data 12, processes the data 12, and feeds the processed data to a trained model 18. The raw input data 12 can be sets of training data, as will be discussed in further detail below. The trained model system 18 receives input data 20 and generates output data 22. The input data 20 can be data desired to be processed and classified by the system 10, and the output data 22 can include classified data. The model training system 14 includes a set packing engine 16.

The set packing engine 16 models data association as a minimum weight set packing formulation (“MWSP”), which is framed using sets of observations and hypotheses denoted D and G respectively, which are index by d and g respectively. The mapping of observations to hypotheses is described using matrix G E {0, 1}^{|D|×G} where G_{dg}=1 if hypothesis g includes observation d. Real valued costs are associated to hypotheses using Γ∈ [symbol] ^{|G|} where Γ_{g} is a cost associated with hypothesis g. The MWSP is formulated as an integer linear program (“ILP”) using γ_{g}∈{0, 1} where γ_{g}=1 if hypothesis g is included in the set packing, as is expressed in Equation 1, below:

$${min}_{{γ}_{g} ∈ \{ 0 , 1 \} ; ∀ g ∈ 𝒢} {\sum }_{g ∈ G} {Γ}_{g} {γ}_{g} \\ \begin{matrix}{\sum }_{g ∈ 𝒢} {G}_{dg} {γ}_{g} \leq 1 & ∀ d ∈ 𝒟\end{matrix} \qquad Equation 1$$

In Equation 1, the objective of optimization is the total cost of all hypotheses in the packing. For every observation d∈D, there is one constraint in Equation 1 that states that no more than one selected hypothesis contains observation d. In an example, the cost of a hypothesis consisting of zero observations is zero.

Prior art systems generally generate cost terms by training a standard linear classifier to determine the probability a variable/pair of variables takes on a given label/pair of labels. The output probabilities are converted to cost terms by taking the negative log of the probability. However, this is not a mathematically principled approach since it does not consider the ILP context, in which a complete solution to all variables is produced. To correctly model the ILP used to produce a solution, the system 10 uses structured support vector machines (“SVM”). A structured SVM learns a mechanism to produce cost terms for ILPs such that the optimal solution to that ILP is similar to the ground truth (information provided by direct observation). The system 10 learns a structured SVM from large amounts of labeled data using a cutting plane approach where the ground truth solution is separated from other solutions generated in the course of training the structured SVM. Learning for structured SVMs requires repeatedly solving ILPs (or linear programs “LPs”) across problem instances, making learning on large data sets challenging. Other mechanisms that can be used by the system 10 to learn cost terms include herding, which is designed to decrease computational requirements relative to the structured SVM, and provides multiple solutions for a problem instance akin to samples from a probability distribution over solutions.

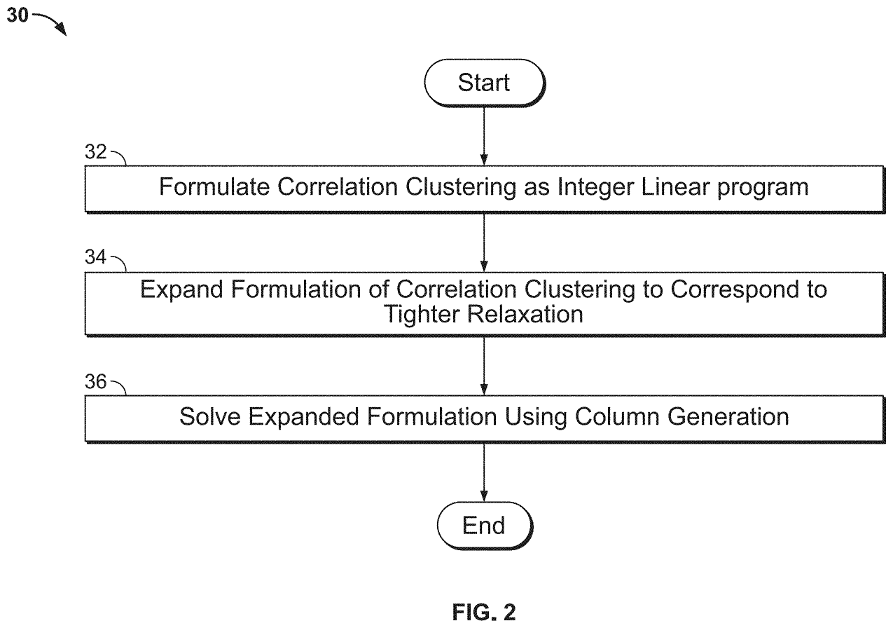

FIG. 2 is a flowchart illustrating the overall process steps being carried out by the system 10, indicated generally at method 30. The process steps of method 20 will be discussed in relation to the framework of the set packing engine 16. Specifically, method 20 will discuss using expanded representation for MWSP problems, and the solutions via column generation.

In step 32, the system 10 formulates correlation clustering as an ILP (integer linear program). Specifically, a graph is expressed with a node set D indexed by d, edge set c indexed by (d₁, d₂) with weights θ∈ [symbol] ^{|D|×D} indexed by (d₁, d₂). Correlation clustering partitions the nodes into sets, so as to minimize the sum of the within cluster edges. Correlation clustering is known to be NP-Hard problem. The system 10 uses decision variables x∈{0, 1}^{|D|×|D|}, which are index with d, j, where x_{dj}=1 if node d is in cluster j. Clusters are indexed by j, and lie in J={0, 1, 2, |D|}. Expression y∈{0, 1}^{D×D×D} describes co-association. Specifically, y_{d1d2j}=1 if d₁, d₂ are part of a common cluster j. Accordingly, correlation clustering as an ILP is expressed by Equation 2-7, below:

$$\begin{matrix}{min}_{\begin{matrix}x \geq 0 \\ y \geq 0\end{matrix}} {\sum }_{\begin{matrix}{d}_{1} , {d}_{2} ∈ ɛ \\ j ∈ 𝒥\end{matrix}} {y}_{{d}_{1} {d}_{2} j} {θ}_{{d}_{1} {d}_{2}} & Equation 2 \\ \begin{matrix}{\sum }_{j ∈ 𝒥} {x}_{dj} = 1 & ∀ d ∈ 𝒟\end{matrix} & Equation 3 \\ \begin{matrix}{y}_{{d}_{1} {d}_{2} j} \underline{<} {x}_{{d}_{1} j} & ∀ ( {d}_{1} , {d}_{2} ) ∈ ɛ , j ∈ 𝒥\end{matrix} & Equation 4 \\ \begin{matrix}{y}_{{d}_{1} {d}_{2} j} \underline{<} {x}_{{d}_{2} j} & ∀ ( {d}_{1} , {d}_{2} ) ∈ ɛ , j ∈ 𝒥\end{matrix} & Equation 5 \\ \begin{matrix}{x}_{{d}_{1} j} + {x}_{{d}_{2} j} - {y}_{{d}_{1} {d}_{2} j} & ∀ ( {d}_{1} , {d}_{2} ) ∈ ɛ , j ∈ 𝒥\end{matrix} & Equation 6 \\ {x}_{dj} ∈ \{ 0 , 1 \} & Equation 7\end{matrix}$$

The objective of Equation 2 is to minimize the sum of the within cluster edges. Equation 3 is a constraint that enforces that every node is assigned to exactly one cluster. Equations 4, 5, and 6 are constraints that collectively enforce that γ_{d1d2j}=1 if x_{d1j}=1 and x_{d2j}=1. Equation 7 is a constraint that enforces integrality of x. It is noted that the integrality of x ensures that y is also integral. The optimization in Equation 2 in which Equation 7 is ignored is referred to as the compact formulation of correlation clustering.

In step 34, the system 10 expands the formulation of the correlation clustering to correspond to a tighter relaxation. By expanding the formulation, the system 10 increases optimization speed. Specifically, the system 10 generates an expanded formulation of correlation clustering that corresponds to a tighter relaxation than the compact formulation. The power set of D denoted G is indexed with g. The term G is expressed using G∈{0, 1}^{|D|×|G|} where G_{dg}=1 if d is in g. The cost associated with each member of g∈G is defined as the sum of all edges within the cluster g. The cost of clusters is expressed using Γ∈ [symbol] ^{|G|} which is indexed with g, where Γ_{g} is the cost associated with cluster g, and is defined by Equation 8 below:

$${Γ}_{g} = {\sum }_{( {d}_{1} , {d}_{2} ) ∈ ɛ} {G}_{{d}_{1} g} {G}_{{d}_{2} g} {θ}_{{d}_{1} {d}_{2}} \qquad Equation 8$$

Equations 9-11, below, frame optimization as selecting the lowest cost non-overlapping subset of G:

$$\begin{matrix}{min}_{{γ}_{g} \geq 0 ∀ g ∈ 𝒢} {\sum }_{g ∈ G} {Γ}_{g} {γ}_{g} & Equation 9 \\ \begin{matrix}{\sum }_{g ∈ 𝒢} {G}_{dg} {γ}_{g} \leq 1 & ∀ d ∈ 𝒟\end{matrix} & Equation 10 \\ \begin{matrix}{y}_{g} ∈ \{ 0 , 1 \} & ∀ g ∈ 𝒢\end{matrix} & Equation 11\end{matrix}$$

The objective in Equation 9 is to minimize the sum of the costs of the clusters selected. The constraint in Equation 10 enforces that every node is assigned to no more than one cluster. If the solution γ does not select a cluster that includes d, then d is in a cluster by itself. The constraint in Equation 11 enforces that γ is integral. The optimization expressed in Equation 9, where Equation 11 is ignored, is referred to as expanded LP relaxation.

In step 36, the system 10 solves the expanded formulation using column generation. Specifically, column generation circumvents the problem of the massive size of the set of hypothesis by constructing a sufficient subset of G denoted Ĝ so that solving the LP relaxation of Equation 9 over Ĝ provides the same objective as solving over G. Construction of Ĝ is performed in a cutting plane manner using the Lagrangian dual of the LP relaxation of Equation 9 defined using Ĝ, which will be referred to as the restricted master problem (“RMP”). Primal and dual LP relaxations of Equations 9-11 are expressed in Equation 12, below, where the dual LP relaxation is described using dual variables λ_{d}≥0 for all d∈D:

$${min}_{\begin{matrix}{γ}_{g} \geq 0 \\ \begin{matrix}{\sum }_{g ∈ \hat{𝒢}} {G}_{dg} {γ}_{g} \leq 1 & ∀ d ∈ 𝒟\end{matrix}\end{matrix}} {\sum }_{g ∈ 𝒢} {Γ}_{g} {γ}_{g} = {max}_{\begin{matrix}{λ}_{d} \geq 0 ; ∀ d ∈ 𝒟 \\ \begin{matrix}{Γ}_{g} + {\sum }_{d ∈ 𝒟} {G}_{dg} {λ}_{d} \geq 0 & ∀ g ∈ \hat{𝒢}\end{matrix}\end{matrix}} {\sum }_{d ∈ 𝒟} - {λ}_{d} \qquad Equation 12$$

The dual form Equation 12 has a finite number of variables and |G| constraints, which allows the system 10 to use a cutting plane method to solve the dual form. After the system 10 uses the cutting plane approach to solves the dual form, the corresponding primal solution is provably optimal. The use of the cutting plane method in the dual form can require access to an oracle that provides a violated dual constraint given a dual solution λ. This violated dual constraint corresponds to a negative reduced cost primal variable. The task of finding the lowest reduced cost primal variable is referred to as pricing, whose corresponding optimization is expressed in Equation 13, below:

$${min}_{g ∈ 𝒢} {Γ}_{g} + {\sum }_{d ∈ 𝒟} {G}_{dg} {λ}_{d} \qquad Equation 13$$

The optimization in Equation 13 is often not solved by search, but instead as an integer program or a dynamic program. The system 10 can employ specialized solvers to solve the pricing problems that exploit the special structure found in specific problem domains.

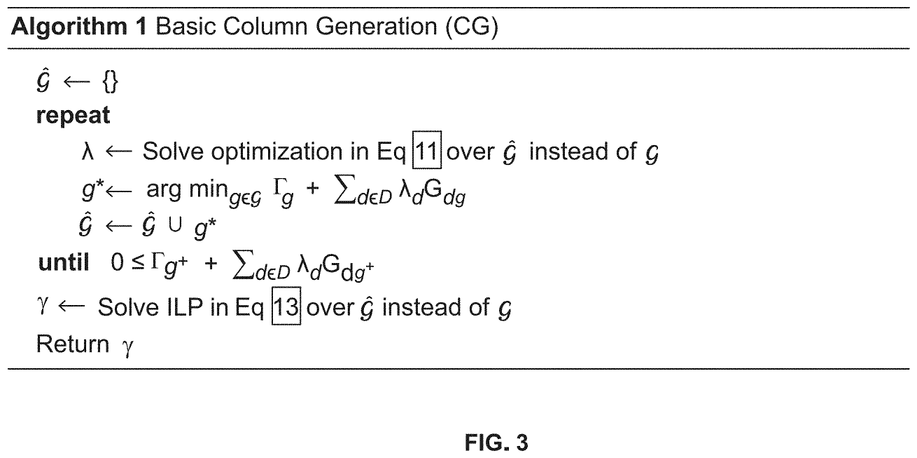

FIG. 3 is an illustration of an algorithm for column generation in connection with step 36. Specifically, Ĝ is set to equal an empty set, then iterated between solving optimization in Equation 12 over Ĝ, and adding elements to Ĝ using Equation 13. When no violated dual constraints exist, the system 10 terminates column generation. For practical problems, the primal form of Equation 12 is generally integral at termination of the column generation. However, if the LP relaxation in Equation 12 is loose, an approximate solution is produced by exactly or approximately solving Equation 12 over set Ĝ instead of G. The relaxation in Equation 12 can be tightened with subset-row inequalities, as will be discussed in detail, below.

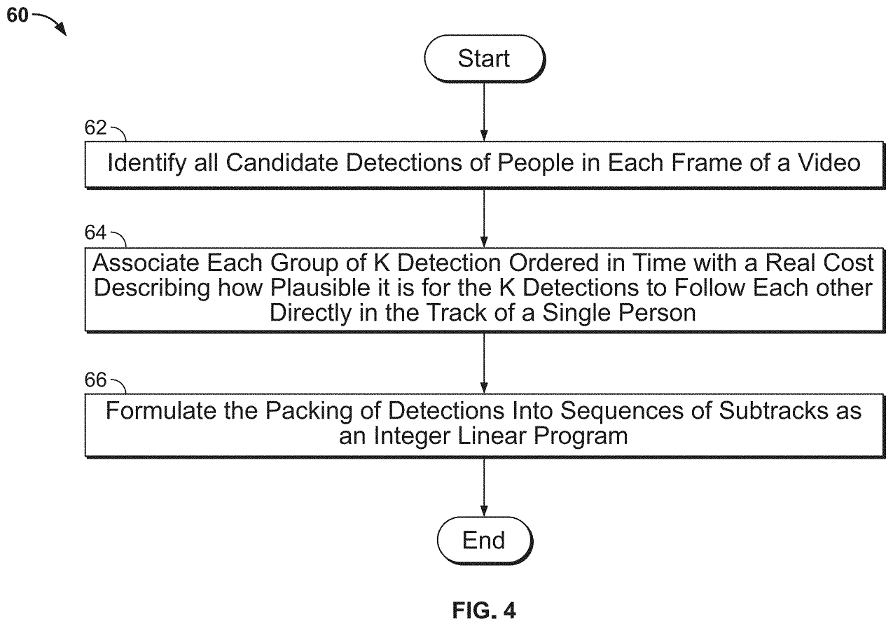

FIG. 4 is a flowchart illustrating process steps being carried out by the system 10 to generate a MW SP formulation of multi-person tracking, indicated generally in method 60. Multi-person tracking is the task of identifying and tracking each unique person in a video. For example, multi-person tracking can be used for security applications, applications including autonomous vehicles, etc. In multi-person tracking, the specific identity of the people in an image is unknown. Combinatorial optimization can be applied to multi-person tracking in the form of min-cost network flow techniques and MWSP.

In step 62, the system 10 identifies all candidate detections of people in each frame of a video. For example, the system 10 can use a classifier, such as an ANN (artificial neural network), to perform the identifications. It is noted that some of these detections can be false detections.

In step 64, the system 10 associates each group of K detections ordered in time, each on a separate frame, with a real cost describing how plausible it is for the K detections to follow each other directly in the track of a single person. In an example, for a single user, K can be any real number (e.g., 3, 4, 5, etc.). These sets can be referred to as subtracks in the present disclosure.

The parameter K trades off modeling power and computation requirements. The set of subtracks is pruned by relying on the fact that most subsets of K are non-sensible since the detections are not in sufficiently visually similar to correspond to a common person. Similarly subtracks that do not follow the known statistics of human motion are removed, e.g., humans cannot teleport across space within a few frames of video.

In step 66, the system 10 formulates the packing of detections into sequences of subtracks as an ILP, and solves the IPL using column generation. Specifically, the system 10 employs a MWSP formulation in which detections correspond to observations and complete tracks correspond to sequences of subtracks. The cost of a track is the sum of the costs of the subtracks that compose it plus a constant offset. The constant offset penalizes/rewards having additional people in the video which models a Bayesian prior belief on the number of people in the image.

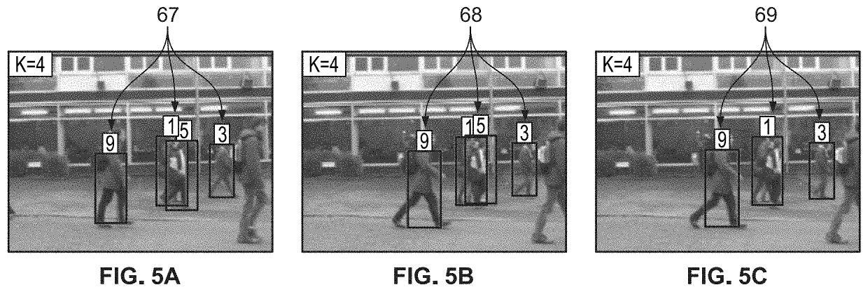

FIGS. 5A-5C are a set of images showing multi-object tracking. Specifically, observations correspond to detections of people and hypotheses to tracks of people moving across time. The system 10 uses numbers to denote the bounding boxes 67, 68, 69 of a common person across frames.

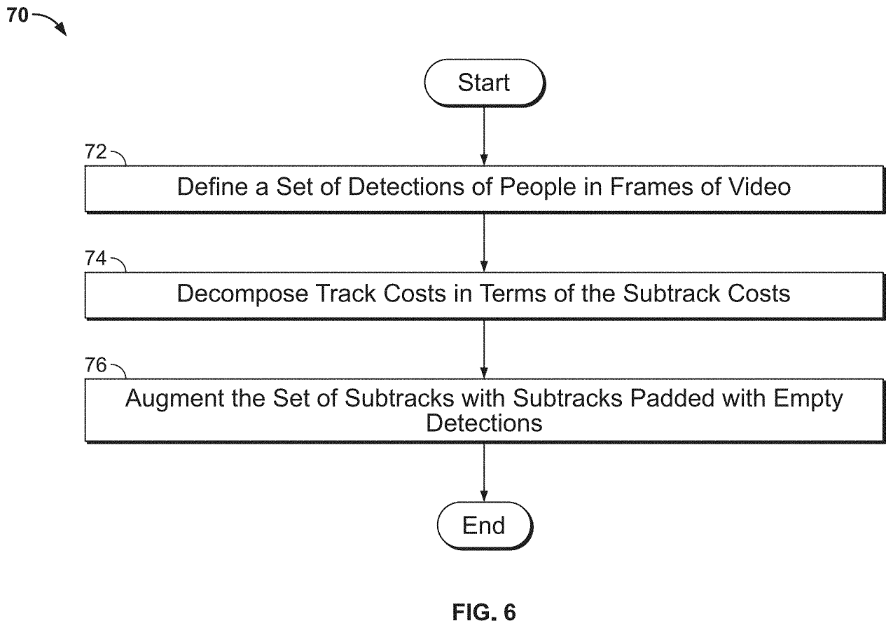

FIG. 6 is a flowchart illustrating process steps being carried out by the system 10 to generate a multi-person tracking MWSP formulation for data association, indicated generally at method 70. By way of example, the system 10 uses a Markov model for scoring the quality of a track (hypothesis). Specifically, the Markov model incorporates scores corresponding to the statistical support for subsequences of detections within a track called subtracks, whose scores can depend arbitrarily on detections across several frames. The Markov model is defined to be K'th order where K is a user defined modeling parameter that trades off optimization difficulty and modeling power. Those skilled in the art understand that other models for scoring can be used.

In step 72, the system 10 defines a set of detections (observations) of people in frames of video as V. By way of example, S to denote a set of subtracks, each of which contains K detections. For a given subtrack s∈S, sₖ indicates the k'th detection in the sequence s={s₁, . . . , s_{K}} ordered by time from earliest to latest. It is noted that the detections that compose a subtrack need not be consecutive in time, thus permitting a person to disappear and reappear in video. The mapping of subtracks to tracks is described using T∈{0, 1}^{|S|×|G|} where T_{sg}=1 indicates that track g contains subtrack s as a sub-sequence.

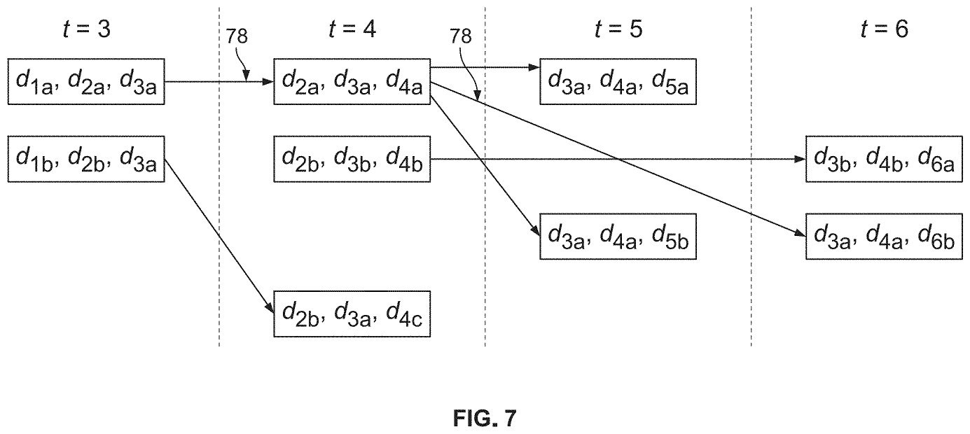

FIG. 7 is an illustration showing the subtracks. Specifically, FIG. 7 illustrates possible tracks and subtracks (boxes) where directed arrows indicate the valid successors of a given subtrack. The subtracks are ordered by the time of their final detection. It is noted that a subtrack can skip some time steps, e.g., [d_{2b}, d_{3d}, d_{5b}] which describes occlusion at time four. Lines 78 indicate a single track that consists of detections ordered in time d₁ₐ, d₂ₐ, d₃ₐ, d₄ₐ, d_{6b}.

The set of tracks are denoted as G where a track is a sequence of subtracks ordered in time where the latest K−1 elements in time of any subtrack s¹ in the sequence are the earliest K−1 elements of a subtrack s² that immediately succeeds s¹. A track can be equivalently described as a sequence of detections ordered in time or a sequence of subtracks ordered in time.

Returning to FIG. 6, in step 74, the system 10 decomposes track (hypothesis) costs F in terms of the subtrack costs θ∈ [symbol] |^{S}| where each subtrack s is associated with cost θₛ. Positive/negative values of θₛ discourage/encourage the use of the sub-track s. The system 10 models a prior on the number of tracks in an image using θ⁰ which is the cost for instancing a track. Positive/negative values of θ⁰ discourage/encourage the presence of more tracks in the packing. Using θ, the system defines the cost of a track g denoted Γ_{g} using Equation 14, below:

$${Γ}_{g} = {θ}^{0} + {\sum }_{s ∈ 𝒮} {T}_{sg} {θ}_{s} \qquad Equation 14$$

To permit the construction of tracks that have fewer detections than Km, in step 76, the system 10 augments the set of subtracks with subtracks padded with empty detections. Such subtracks have no possible predecessors or successors.

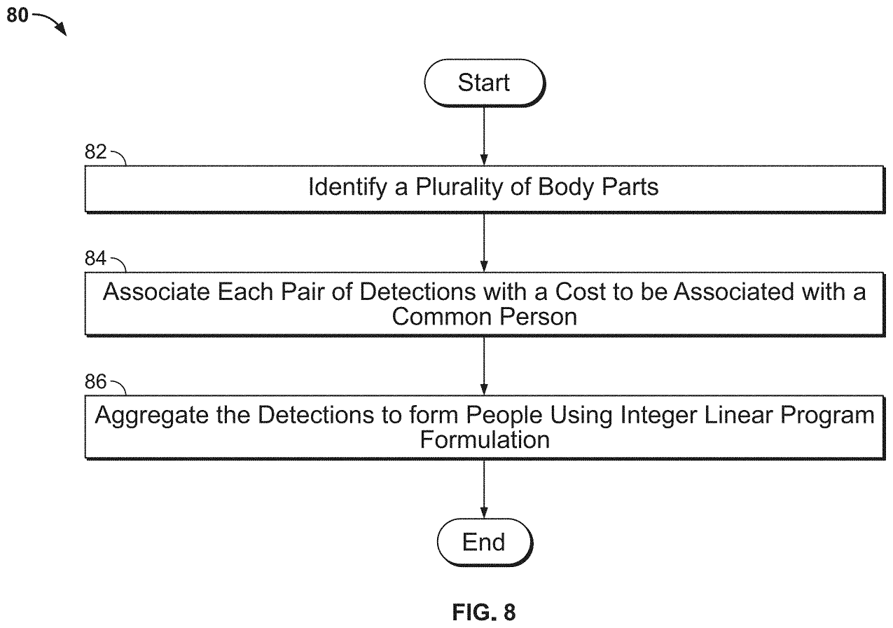

FIG. 8 is a flowchart illustrating process steps being carried out by the system 10 to generate a MW SP formulation of multi-person pose estimation (“MPPE”), indicated generally in method 80. MPPE is the task of identifying each unique person in an image, and annotating their body parts. As in tracking, specific identities of the people are not known in advance. MPPE is relevant in multiple domains including but not limited to autonomous driving, rehabilitation, and defense applications.

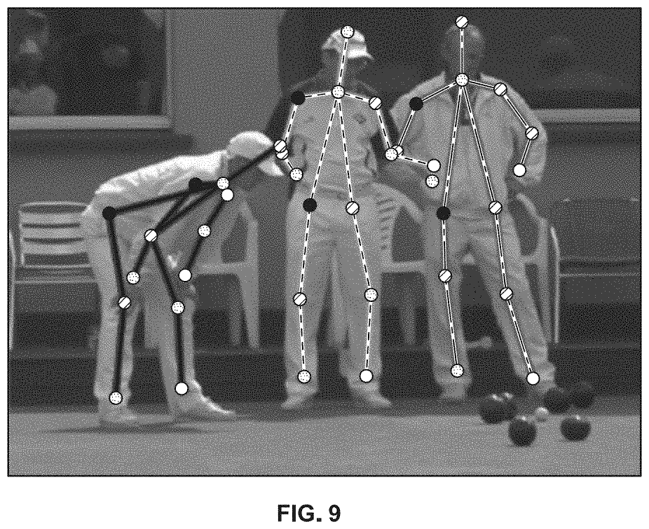

FIG. 9 is an image showing multi-person pose estimation. Specifically, observations correspond to detections of body parts, and hypotheses to people. Lines of a common color associate a person to the average position of each of his body parts. There is a surjection of body parts (head, neck, etc.) to color for dots that indicate the body part.

Returning to FIG. 8, in step 82, the system 10 identifies a plurality of body parts. For example, the system 10 identities all instances of each of fourteen human body parts (head, neck, and left/right of the following: shoulder, elbow, wrist, hip, knee, ankle). The system 10 can use an ANN to perform the identification. It is noted that some of the detections can be false detections. Some sets of detections correspond to the same ground truth detection, but are separated in pixel space.

In step 84, a classifier (such as an artificial neural network) associates each pair of detections with a cost to be associated with a common person. The cost is made using a negative log odds ratio of probability that the two detections are/are not associated with a common person. Similarly, a cost is made to associate each detection with a person. The classifiers take as input local statistics of pixel values around the detections, and or spatial, angular statistics concerning the relative location of the pair of detections. The cost terms over pairs of detections are referred to as pairwise, and those over a single detections is referred to as a unary.

It is noted that person detection in computer vision relies traditionally on tree (pictorial) structured models, which describe the feasibility of poses of the human body, according to a cost function defined on a graph, where nodes correspond to body parts, and edges indicated adjacency. Thus, pairwise cost terms are non-zero only between adjacent detections corresponding to the same, or adjacent body parts in the tree model.

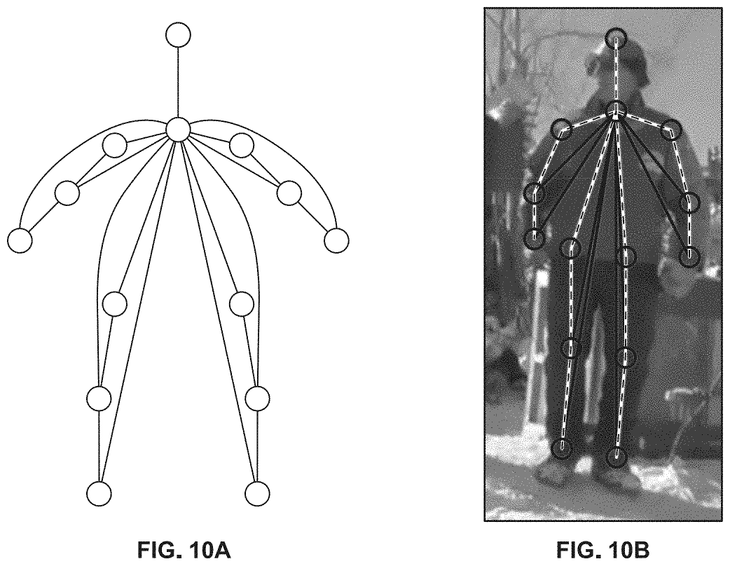

FIGS. 10A-B are illustrations showing a tree model, augmented with additional connections where additional connections trade off optimization difficulty and modeling power. Specifically, FIGS. 10A-B shows the system 10 modeling a person as an augmented-tree, in which each node represents a body part, the edges light grey are connections of traditional pictorial structure, and the edges dark grey are augmented connections from neck to all non-adjacent parts of the neck. In FIG. 10A, the augmented tree model is displayed as a stick figure. In FIG. 10B, the augmented-tree model is superimposed on an image of a person.

Returning to FIG. 8, in step 86, the system 10 aggregates the detections to form people using an ILP formulation that admits efficient inference using column generation. Specifically, the system 10 employs an MWSP formulation where elements correspond to detections of body parts, and sets correspond to people. The cost of a person is the sum of the unary and pairwise terms associated with the included detections plus an offset. As in tracking the constant offset penalizes/rewards having additional people in the image, which models a Bayesian prior belief on the number of people in the image.

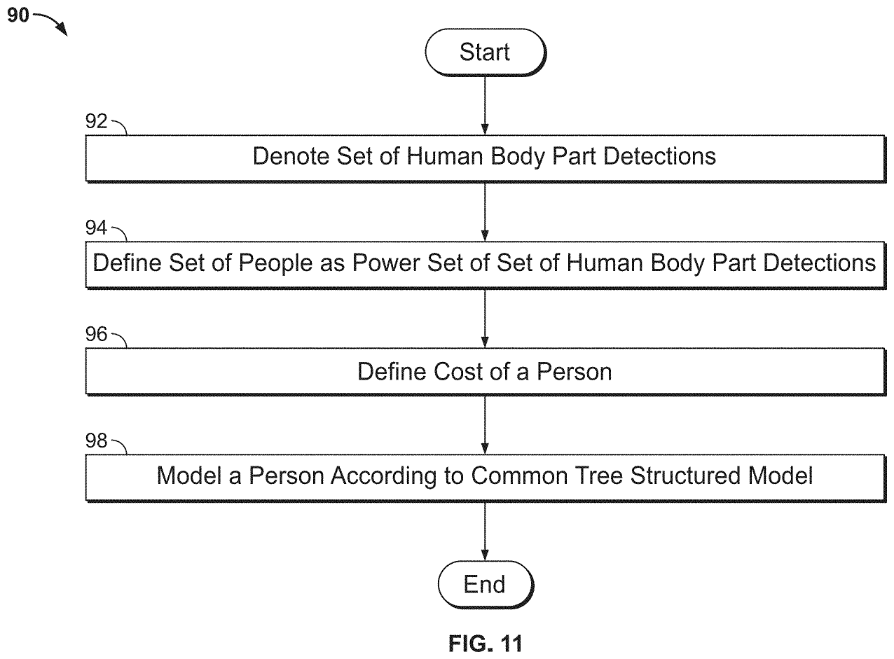

FIG. 11 is a flowchart illustrating process steps being carried out by the system 10 to generate a MPPE MWSP formulation for data association, as generally indicated in method 90. In step 92, the system 10 uses the term V to denote the set of human body part detections (observations). A surjection of detections to human body parts (head, neck, and left/right of the following: shoulder, elbow, wrist, hip, knee, ankle) is denoted using R_{d} to denote the human body part associated with detection d.

In step 94, the system 10 defines a set of people (hypotheses) G as the power set of V. It is noted that a person can contain more than one detection of any given body part. This can be a modeling decision and is a consequence of the body part detector firing multiple places in close proximity corresponding the same ground truth body part. Similarly, since human body parts are occluded in real images it is possible for a hypothesis to contain zero detections of some body parts.

In step 96, the system 10 defines a cost of a person using terms θ¹∈ [symbol] |^{D|}, and θ²∈ [symbol] ^{|D|×|D|}, which is index with d, and d₁,d₂ respectively. The terms θ¹, θ² are referred to as unary and pairwise respectively. The term θ_{d}¹ denotes the cost of including detection d in a person. Similarly, the term θ²_{d1d2} denotes the cost of including detections d₁, d₂ in a common person. Here positive/negative values θ_{d} discourage/encourage the use of the detection d in a person. Similarly positive/negative values of θ_{d1d2} discourage/encourage the presence of d₁, d₂ jointly in a single person. The system 10 models a prior on the number of people in an image using θ⁰ to denote a constant cost associated with instancing a person. Here, positive/negative values of θ⁰ discourage/encourage the presence of more people in the packing.

In step 98, the system 10 models a person according to a common tree structured model. The system 10 can augment the tree structure by connecting the neck to every other body part, the left shoulder to the right shoulder, and the right hip to the right shoulder. These augmentations improve performance, as will be discussed in greater detail below. The augmented tree structure is respected with regards to the costs, thus θ_{d1d2} can only be non-zero if R_{d1}=R_{d2}, or if R_{d2} is a child of R_{d1} in the augmented tree. The mapping of people to costs is defined by Equation 15, below:

$${Γ}_{g} = {θ}^{0} + {\sum }_{d ∈ 𝒟} {θ}_{d}^{1} {G}_{dg} + {\sum }_{\begin{matrix}{d}_{1} ∈ 𝒟 \\ {d}_{2} ∈ 𝒟\end{matrix}} {θ}_{{d}_{1} {d}_{2}}^{2} {G}_{{d}_{1} g} {G}_{{d}_{2} g} \qquad Equation 15$$

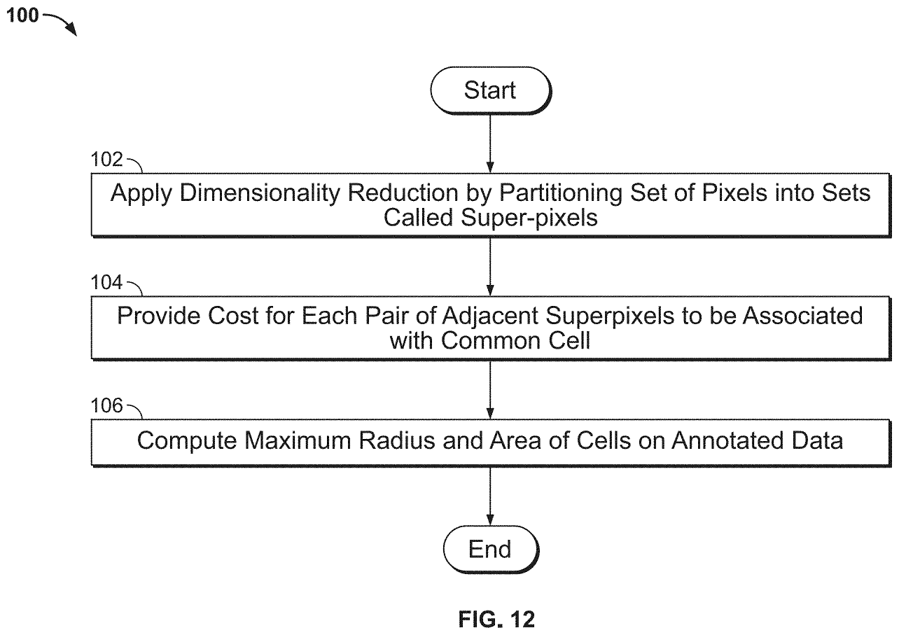

FIG. 12 is a flowchart illustrating process steps being carried out by the system 10 to generate multi-cell segmentation, indicated generally in method 100. Multi-cell segmentation is the task of identifying each unique biological cell in an image and identifying the pixels associated with that cell. This is useful in domains such as image microscopy, where characterizing the movements and activities of cells is important, but the capacity of human annotators is limited.

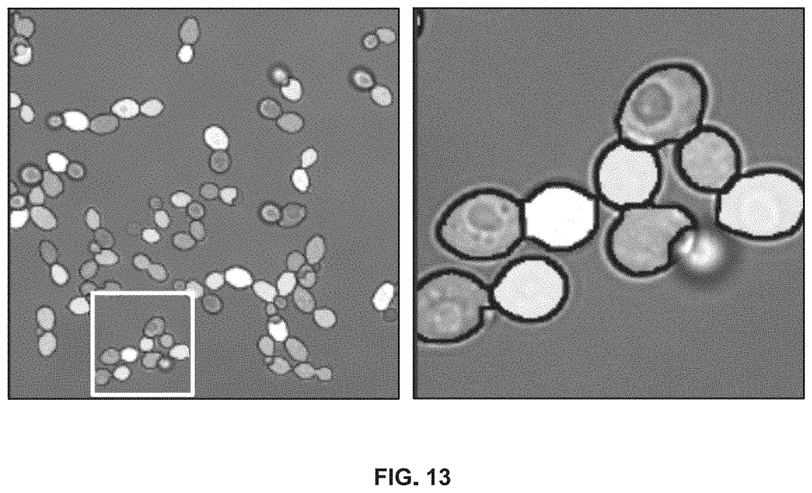

FIG. 13 is an image showing a multi-cell instance segmentation. Specifically, observations correspond to superpixels, and hypotheses are complete biological cells. The system 10 can color code cells arbitrarily, with each cell being provided a single color.

Returning to FIG. 12, in step 102, given a biological image, the system 10 applies dimensionality reduction by partitioning set of pixels into sets called super-pixels. The system 10 achieves this by aggregating pixels that a classifier is extremely confident correspond to the same cell or are both background. The classifier uses local spatial and color statistics. This conversion reduces the space of millions of pixels to thousands of super-pixels, and rarely meaningfully compromises the boundaries any cells in the ground truth.

In step 104, for each pair of adjacent superpixels, the system 10 use a classifier that provides a cost for the pair to be associated with a common cell. Similarly we use a classifier to generate a cost for each superpixel to be part of a cell. These costs are referred to as unary and pairwise, respectively.

In step 106, the system 10 computes a maximum radius and area (volume in 3D images) of cells on annotated data. In step 108, the system 10 formulates identifying each cell in the image as a MWSP problem where elements are superpixels and sets are cells. The cost of a cell is the sum of the pairwise terms associated with pairs of superpixels in the cell, plus the unary terms associated with superpixels in the cell. As in the other applications, the system 10 adds a constant offset to the cost of a cell that penalizes/rewards having additional cells in the image. This offset models a Bayesian prior belief on the number of cells in the image. The system 10 sets the cost of the cell to ∞ if the radius of the cell or the volume of the cell significantly exceeds the known maximum volume and radius of cells on the annotated data.

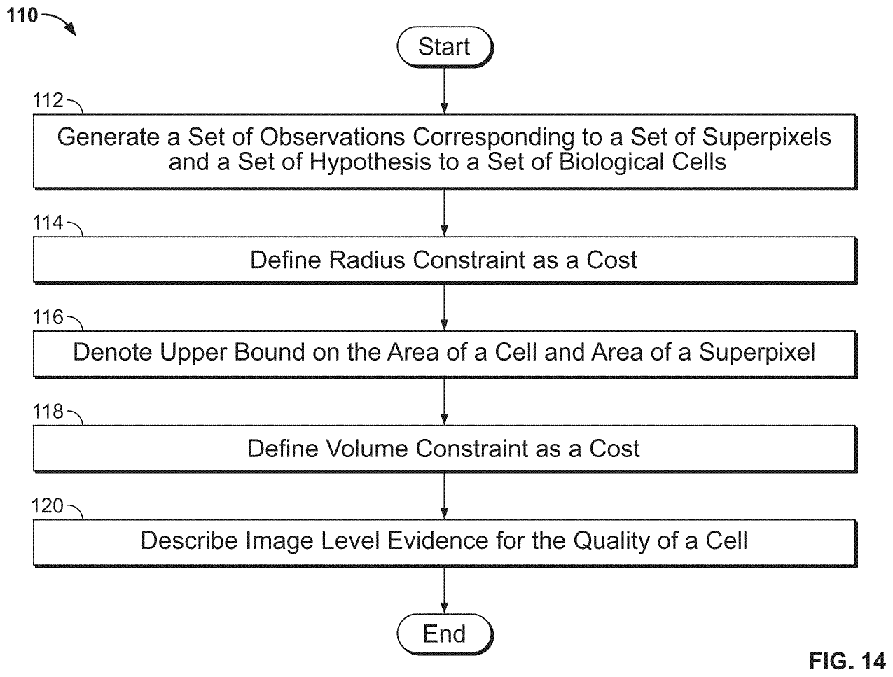

FIG. 14 is a flowchart illustrating process steps being carried out by the system 10 to generate a MWSP formulation of multi-cell segmentation, indicated generally in method 110. In step 112, the system 10 generates a set of observations d∈D corresponding to a set of superpixels and a set of hypothesis G to a set of biological cells. The quality of a cell is defined in terms of obeying the known structural properties of a cell which describe the radius, area (volume in 3D for super-voxels) and agreement with the local image statistics. A constraint on a radius of a cell is set so that for any cell g∈G there exists a super-pixel d*, which is referred to as an anchor, such that all superpixels in the cell g are within a user defined distance Rₘₐₓ of d*. Terms S_{d1d2} denote the distance between the centers of superpixels d₁ and d₂. Spatial compactness is satisfied for a given cell g∈G if the following in Equation 16, below, holds:

∃d*∈ [symbol] s.t. [G_{dg}=1]⇒[S_{d*d}≤Rₘₐₓ] ∀d∈ [symbol] Equation 16

In step 114, the system 10 defines the radius constraint as a cost. Specifically, for any g∈G, a penalty of ∞ is added to Γ_{g} if g does not follow the radius constraint. The radius constraint as optimization is expressed in Equation 17, below:

$${min}_{{d}^{*} ∈ 𝒟} ( {\sum }_{d ∈ 𝒟} [ {S}_{{d}^{*} d} > {R}_{max} ] {G}_{dg} ) ∞ \qquad Equation 17$$

Optionally, the system 10 can require that the anchor be present in the cell. This changes Equations 16 and 17 to the following formula, expressed in Equation 18, below:

$$∃ {d}^{*} ∈ 𝒟 s . t . {G}_{{d}^{*} g = 1} and \\ \begin{matrix}[ {G}_{dg} = 1 ] ⇒ [ {S}_{{d}^{*} d} > {R}_{max} ] & ∀ d ∈ 𝒟\end{matrix} \\ {min}_{{d}^{*} ∈ 𝒟} ( 1 - {G}_{{d}^{*} g} ) ∞ + ( {\sum }_{d ∈ 𝒟} [ {S}_{{d}^{*} d} > {R}_{max} ] {G}_{dg} ) ∞ \qquad Equation 18$$

Next, the constraint on the area of a cell is considered. In step 116, the system 10 uses Vₘₐₓ to denote the upper bound on the area of a cell, and V_{d} to denote the area of a superpixel d. A cell g∈G satisfies the constraint on the area of a cell if the following, expressed below in Equation 19, holds:

$${\sum }_{d ∈ 𝒟} {V}_{d} \leq V max \qquad Equation 19$$

In step 118, the system 10 defines the volume constraint as a cost. For any g∈G, a penalty of ∞ is added to Γ_{g} if g does not follow the volume constraint. The volume constraint is expressed as a cost using Equation 20, below:

$$[ {V}_{ma x} < {\sum }_{d ∈ 𝒟} {G}_{d g} {V}_{d} ] ∞ \qquad Equation 20$$

In step 120, the system 10 describes the image level evidence for the quality of a cell using θ_{d} and θ_{d1d2}. Specifically, the system 10 uses θ_{d} to denote the cost for superpixel d to be part of any cell. Similarly, the system 10 uses θ_{d1d2} to denote the cost for d₁ and d₂ to belong in a common cell. Positive/negative values θ_{d} discourage/encourage the use of the superpixel d in a cell. Similarly, positive/negative values of θ_{d1d2} discourage/encourage the presence of d₁, d₂ jointly in a single cell. The system 10 model a prior on the number of cells in an image using θ⁰ to denote a cost associated with instancing a cell. Positive/negative values of θ⁰ discourage/encourage the presence of more cells in the packing. The cost Γ_{g} of an hypothesis g is expressed in Equation 21, below:

$${Γ}_{g} = {θ}^{0} + {\sum }_{d ∈ 𝒟} {θ}_{d}^{1} {G}_{d g} + {\sum }_{{d}_{1} {d}_{2} ∈ 𝒟} {θ}_{{d}_{1} {d}_{2}}^{2} {G}_{{d}_{1} g} {G}_{{d}_{2} g} + [ {V}_{ma x} < {\sum }_{d ∈ 𝒟} {G}_{d g} {V}_{d} ] ∞ + {min}_{{d}^{*} ∈ 𝒟} ( {\sum }_{d ∈ 𝒟} [ {S}_{{dd}^{*}} > {R}_{ma x} ] {G}_{d g} ) ∞ \qquad Equation 21$$

The following will discuss the system 10 solving the pricing problem of Equation 13 in the context of the MW SP formulations. In pricing for multi-object tracking, the system 10 formulates the task of identifying the lowest reduced cost track (hypothesis) as a dynamic program. The system 10 considers the structure of that dynamic program and specifies that a subtrack s may be preceded by another subtrack ŝ, if the least recent K−1 detections in s correspond to the most recent K−1 detections in ŝ. The system 10 denotes the set of valid subtracks, that may precede a subtrack s as {→s}. The system 10 uses lₛ to denote the reduced cost of the lowest reduced cost track, that terminates at subtrack s. Ordering the subtracks by the time of last detection allows efficient computation of l, using the following dynamic programming expressed in Equation 22, below:

$${𝓁}_{s} ← {θ}_{s} + {λ}_{{s}_{K}} + min \{ {min}_{\hat{s} ∈ \{ ⇒ s \}} {𝓁}_{\hat{s}} , {θ}_{0} + {\sum }_{k = 0}^{K - 1} {λ}_{{s}_{k}} \} \qquad Equation 22$$

The system 10 can choose to add, not only the lowest reduced cost track to Ĝ, but other distinct negative reduced cost tracks. Such strategies can be implemented by the system 10 since the dynamic program produces the lowest reduced cost track terminating at each subtrack. One such strategy adds to Ĝ the lowest reduced cost track terminating at each detection (excluding those with non-negative reduced cost).

In pricing for multi-person pose estimation, the system 10 identifies the lowest reduced cost person (hypothesis), which can be formulated as a set of dynamic programs. A graph is used where nodes correspond to human body parts, and edges indicate adjacency. A subgraph in which the neck is removed corresponds to a tree structure can motivate the use of dynamic pro-gramming to solve the pricing problem. During the pricing step, the system 10 iterates through the power set of neck detections and compute the lowest reduced cost person containing the neck detections. The power set of neck detections is indexed with Ď and [g↔Ď]=1 is used to indicate that the neck detections in g are exactly those in Ď. Pricing for an arbitrary subset of the neck detections Ď is expressed in Equation 23, below:

$${min}_{{g ∈ 𝒢}_{[ g ↔ \breve{𝒟} ] = 1}} {Γ}_{g} + {\sum }_{d ∈ 𝒟} {λ}_{d} {G}_{dp} \qquad Equation 23$$

To solve Equation 23 as a dynamic program, the system 10 enumerates the power set of pairs of adjacent detections in the tree in the problem domain. Specifically, the system 10 provides a notation to assist formulating Equation 23 as a dynamic program. The system 10 uses R to denote the set of human body parts, which is index by r. The system 10 uses S^{r} to denote the power set of detections of part r, and index it with s. The system 10 uses Dr to denote the set of detections of part r. S^{r} is described using S^{r}∈{0, 1}^{|D|×|Sr|}, where S^{r}_{ds}=1 indicates that detection d is in set s. For convenience, the system can define the neck as part 0 and thus the power set of neck detections is denoted S⁰.

It is noted that when conditioned on a specific set of neck detections (denoted s⁰), the pairwise costs from the neck detections to all other detections can be added to unary costs of the other detections. Thus, the augmented-tree structure becomes a typical tree structure, and exact inference can be done via dynamic programming. The system 10 makes the tree directed by choosing a single node to be the root arbitrarily, and orienting edges in the graph going away from the root.

The system 10 defines the set of children of any human body part r in the tree graph as {r→}. The system 10 defines μ^{r}_{ŝ} as the reduced cost of the lowest reduced cost sub-tree rooted at r given that its parent \hat{r} takes on state ŝ. The term μ^{r}_{ŝ} includes the cost of the pairwise terms between detections of part \hat{r}, with detections of part r, as expressed in Equation 24, below:

$${μ}_{\hat{s}}^{r} = {min}_{s ∈ {S}^{r}} {\sum }_{{\hat{d} ∈ {𝒟}^{r}}_{d ∈ {𝒟}^{r}}} {S}_{\hat{d} s}^{\hat{r}} {S}_{d s}^{r} {θ}_{\hat{d} d}^{2} + {v}_{s}^{r} \qquad Equation 24$$

Specifically, in Equation 24, the term

$${\sum }_{{\hat{d} ∈ {D}^{r}}_{d ∈ {D}^{r}}} {S}_{\hat{d} s}^{\hat{r}} {S}_{ds}^{r} {θ}_{\hat{d} d}^{2} \qquad$$

computers pairwise costs between part r and its parent \hat{r}, while v^{r}ₛ accounts for the cost of the sub-tree rooted at part ra with state s, and is defined by Equations 25 and 26, below:

$$\begin{matrix} {v}_{s}^{r} = {ρ}_{s}^{r} + {\sum }_{\overline{r} ∈ \{ r -> \}} {μ}_{s}^{\overline{r}} & Equation 25 \\ {ρ}_{s}^{r} = {\sum }_{d ∈ {𝒟}^{r}} ( {θ}_{d}^{1} + {λ}_{d} ) {S}_{ds}^{r} + {\sum }_{{{d}_{1} ∈ {𝒟}^{r}}_{{d}_{2} ∈ {𝒟}^{r}}} {θ}_{{d}_{1} {d}_{2}}^{2} {S}_{{d}_{1} s}^{r} {S}_{{d}_{2} s}^{r} + {\sum }_{{{d}_{1} ∈ {𝒟}^{0}}_{{d}_{2} ∈ {𝒟}^{r}}} {θ}_{{d}_{1} {d}_{2}}^{2} {S}_{{d}_{1} {s}_{0}}^{0} {S}_{{d}_{2} s}^{r} & Equation 26\end{matrix}$$

To compute μ^{r}_{ŝ} for each ŝ∈S^{\hat{r}}, the system 10 needs to iterate over all s∈S^{r}. For most problems, this is feasible. However, considering that |D^{r}|=|D^{\hat{r}}|=15, the system 10 would have to enumerate the joint space of over one billion configurations, which is can be expensive. Accordingly, the system 10 can use nested Benders decomposition, which is able to solve the dynamic program exactly, with computation that scales in practice O(|D^{r}|) time not O(|D^{r}|×|D^{r}|)

In pricing for multi-cell segmentation, the system 10 finds negative reduced cost cells (hypothesis) by exploiting that cells are small and compact. In Equation 21, above, every cell with non-infinite cost is associated with an anchor d* in close proximity to all other super-pixels (observations) that compose the cell. The system 10 solves pricing by conditioning on the choice of the anchor d*, and finds the lowest reduced cost cell denoted g_{d}*, as expressed by Equation 27, below:

$${g}_{{d}^{*}} ← arg {min}_{{g ∈ 𝒢}_{{G}_{d g} = 0 , ∀ d ∉ {𝒟}_{{d}^{*}}}} {\sum }_{d ∈ 𝒟} {θ}^{0} + ( {θ}_{d}^{1} + {λ}_{d} ) {G}_{d g} + {\sum }_{{d}_{1} {d}_{2} ∈ 𝒟} {θ}_{{d}_{1} {d}_{2}}^{2} {G}_{{d}_{1} g} {G}_{{d}_{2} g} \qquad Equation 27$$

The system 10 reconfigures the optimization in Equation 27 as an ILP (seen below in Equations 30-33) using decision variables x∈{0, 1}^{|D|}, y∈0, 1^{|D|×|D|} which are indexed by d and d₁, d₂ respectively, and where x and y are defined in Equations 28 and 28, below:

$$\begin{matrix} {x}_{d} {G}_{d {g}_{{d}^{*}}} & Equation 28 \\ {y}_{{d}_{1} {d}_{2}} = {G}_{{d}_{2} {g}_{{d}^{*}}} {G}_{{d}_{1} {g}_{{d}^{*}}} & Equation 29 \\ {min}_{{{x}_{d} ∈ \{ 0 , 1 \}}_{{{x}_{d} = 0 ∀ d ∉ {𝒟}_{{d}^{*}}}_{{y}_{{d}_{1} {d}_{2} \geq 0}}}} {θ}^{0} + {\sum }_{d ∈ 𝒟} ( {θ}_{d}^{1} + {λ}_{d} ) {x}_{d} + {\sum }_{{d}_{1} {d}_{2} ∈ 𝒟} {θ}_{{d}_{1} {d}_{2}}^{2} {y}_{{d}_{1} {d}_{2}} & Equation 30 \\ {y}_{{d}_{1} {d}_{2}} \leq {x}_{{d}_{1}} ∀ {d}_{1} , {d}_{2} ∈ 𝒟 & Equation 31 \\ {y}_{{d}_{1} {d}_{2}} \leq {x}_{{d}_{2}} ∀ {d}_{1} , {d}_{2} ∈ 𝒟 & Equation 32 \\ - {y}_{{d}_{1} {d}_{2}} + {x}_{{d}_{1}} + {x}_{{d}_{2}} \leq 1 ∀ {d}_{1} , {d}_{2} ∈ 𝒟 & Equation 33\end{matrix}$$

The system enforces Equations 28 and 29 with Equations 31, 32, and 33. Equations 31 and 32 state that γ_{d1d2} cannot be set to one unless both d₁,d₂ are included in the cell g_{d*}. Similarly, Equation 33 states that if both d₁, d₂ are included in g_{d*}, then γ_{d1d2} is set to one. It is noted that γ is entirely governed by x and it does not need to be explicitly required to be integer in order for the ILP solver to produce an integer solution.

The system 10 can generate many distinct hypotheses with negative reduced cost when solving Equation 27 as a consequence solving using different d*. Thus, the system 10 can add to the nascent set Ĝ each hypothesis with negative reduced cost generated by solving Equation 27. The system 10 can resolve the master problem after any negative reduced cost hypothesis is generated. If the anchor is included in a cell for it to be feasible, then xd* is required to be set to one in Equation 30.

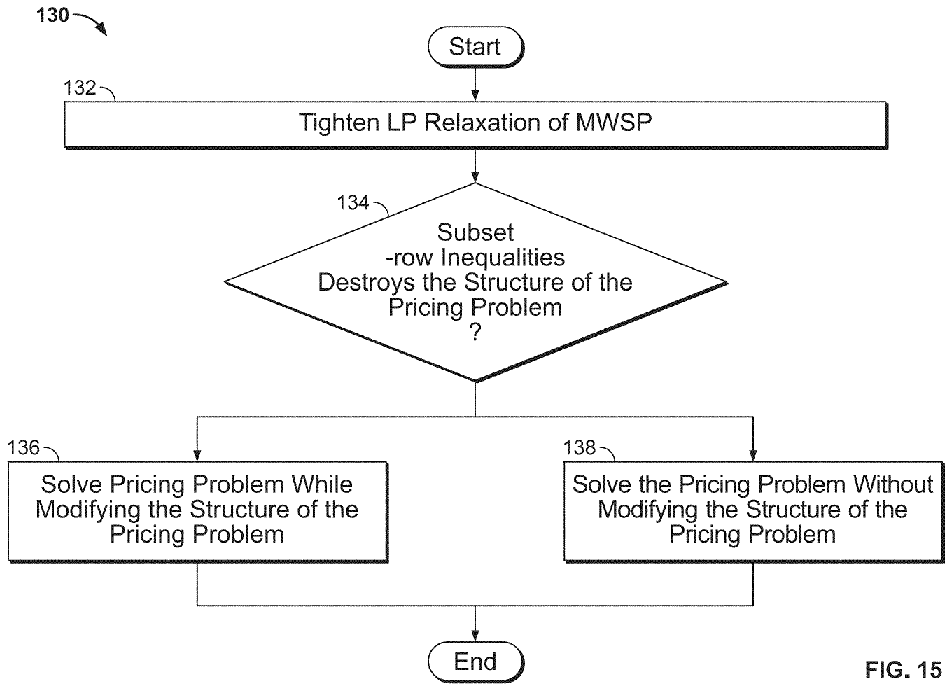

FIG. 15 is a flowchart illustrating process steps being carried out by the system 10 to tightening the LP relaxation of the MWSP (e.g., tightening the restricted master problem using subset-row inequalities), indicated generally in method 130. The system 10 consider four hypothesis G=g₁, g₂, g₃, g₄ over three observations D=d₁, d₂, d₃, where the first three hypotheses each contain two of the three observations {d₁, d₂}, {d₁, d₃}, {d₂, d₃} respectively, and the fourth hypothesis contains all three {d₁, d₂, d₃}. The hypotheses costs are given by Γ_{g1}=Γ_{g2}=Γ_{g3}=−4 and Γ_{g4}=−5. An optimal integer solution sets γ_{g4}=1, and has a cost of −5. A lower cost fractional solution sets γ_{g1}=γ_{g2}=γ_{g3}=0.5 and γ_{g4}=0 which has cost −6. Hence the LP relaxation is loose.

The LP relaxation of MWSP can be tightened by the system 10 employing subset-row inequalities in such a way as to preserve the structure of the pricing problem. The system 10 can add them to the pricing problem, and parameterize them by two integers m₁, m₂ and a subset \hat{D}⊆|D| of cardinality m₁m₂−1. Subset-row inequalities are used to require that the number of hypotheses containing m₁ or more members of |\hat{D}| must be no greater than m₂−1. The most general form of subset-row inequalities is written in Equation 34, below:

$${\sum }_{g ∈ 𝒢} {γ}_{g} ⌊ \frac{{\sum }_{d ∈ 𝒟} {G}_{d g} [ d ∈ \hat{𝒟} ]}{{m}_{1}} ⌋ \leq {m}_{2} - 1 \qquad Equation 34$$

Subset-row inequalities where m1=m2=2 will be referred to as triplets. However, all content in this section is fully applicable to the other subset-rows inequalities modeled in the present disclosure.

In step 132, the system 10 generates an MWSP formulation tightened using triplets. In step 134, the system 10 determines whether the subset-row inequalities destroys the structure of the pricing problem. When the subset-row inequalities do not destroy the structure of the pricing problem, the system 10 proceeds to step 136, where the system 10 solves the pricing problem while modifying the structure of the pricing problem. This allow the system to use subset-row inequalities to tighten the LP relaxation for multi-cell segmentation. When the subset-row inequalities destroys the structure of the pricing problem, the system 10 proceeds to step 138, where the system 10 solves the pricing problem without modifying the structure of the pricing problem. This permits the use of subset-row inequalities to tighten the LP relaxations for multi-person tracking and multi-person pose estimation. Each step will be discussed in further detail below.

In step 132, the system 10 tightens the LP relaxation of MWSP by enforcing that for any set of three unique observations, a number of selected hypotheses that include two or more members can be no larger than one. The system 10 describes the set of sets of three unique observations by C, and index it with c. The membership of c is described using [d∈c], where [d∈c]=1 if observation d is in c, and otherwise [d∈c]=0. The mapping of triplets to hypotheses is described using matrix C∈{0, 1}^{|C|×|G|}, which is index by c, g. Here, C_{cg}=1 if at least two of the observations in c are present in g. The LP relaxation for MWSP tightened using triplets is expressed using Equation 35, below:

$${min}_{{γ}_{g} \geq 0 ∀ g ∈ 𝒢} {\sum }_{g ∈ 𝒢} {Γ}_{g} {γ}_{g} \\ {\sum }_{g ∈ 𝒢} {G}_{d g} {γ}_{g} \leq 1 ∀ d ∈ 𝒟 \\ {\sum }_{g ∈ 𝒢} {G}_{cg} {γ}_{g} \leq 1 ∀ c ∈ 𝒞 \qquad Equation 35$$

A dual form of Equation 35 is expressed in Equation 36 below, which uses dual variables ψ∈ [symbol] |^{C}|, which is index by c, where ψ_{c} is the dual variables associated with the constraint in Equation 35 over c.

$$Eq 35 = {max}_{{{λ}_{d} \geq 0 ; ∀ d ∈ 𝒟}_{{ψ}_{c} \geq 0 ; ∀ c ∈ 𝒞}} - {\sum }_{d ∈ 𝒟} {λ}_{d} - {\sum }_{c ∈ 𝒞} {ψ}_{c} \\ {Γ}_{g} + {\sum }_{d ∈ 𝒟} {G}_{d g} {λ}_{d} + {\sum }_{c ∈ 𝒞} {C}_{cg} {ψ}_{c} \geq 0 ∀ g ∈ 𝒢 \qquad Equation 36$$

The system can solve Equation 35 using a generalization of column generation, called column/row generation (“CRG”). CRG exploits the fact that the dual LP relaxation has a finite number of variables, thus making it amenable to optimization via cutting plane method.

As in column generation, the system 10 uses CRG to construct a sufficient set G by adding negative reduced cost hypothesis (violated dual constraints), given fixed dual variables. CRG augments this procedure by identifying a sufficient set C by identifying violated constraints given a fixed primal solution. CRG begins with sets Ĝ, Ĉ equal to the empty set, then iterates between solving optimization in Equation 35 over set Ĝ, Ĉ, and adding elements to Ĝ, Ĉ. Each iteration produces primal/dual solutions, which facilitate the identification of violated primal/dual constraints. When, no violated primal/dual constraints exist, the system 10 terminates CRG. Identifying violated primal constraints is done by iterating over c∈C, to identify the c∈C, that maximizes Σ_{G∈G}γ_{g}C_{cg}, given fixed γ. While C is too large to include each element as a constraint in the LP relaxation, it is not too large to search over. This is because only triplets, where each detection is associated with a fractional valued hypothesis in γ, need be considered when iterating over c∈C. Finding the most violated dual constraint (which is called pricing) corresponds to the following optimization expressed in Equation 37, below:

$${min}_{g ∈ 𝒢} {Γ}_{g} + {\sum }_{d ∈ 𝒟} {G}_{d g} {λ}_{d} + {\sum }_{c ∈ C} {C}_{cg} {ψ}_{c} \qquad Equation 37$$

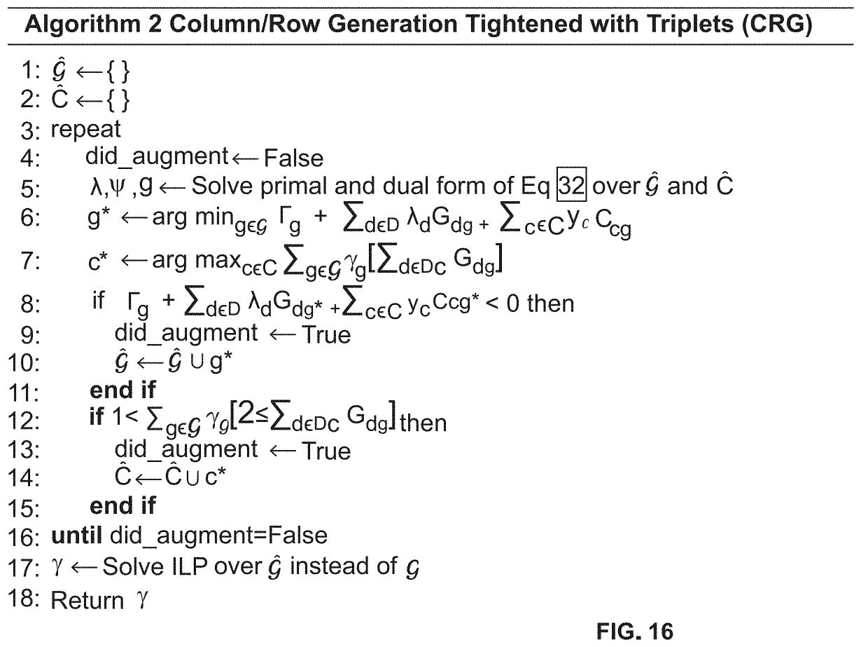

FIG. 16 is an algorithm describing the CRG. Specifically, in lines 0-1, the system 10 initializes the nascent sets of hypotheses Ĝ and triplets Ĉ to the empty set. In lines 2-15, the system 10 construct nascent sets Ĝ and Ĉ. The system 10 iterates until the flag “did_augment” is set to false, meaning that the solution γ satisfies all triplets, and no negative reduced cost hypotheses exist. Specifically, in line 3, the system 10 sets “did_augment” to false, which indicates that the system 10 has not edited Ĝ or Ĉ this iteration. In line 4, the system 10 solves the restricted master problem producing primal and dual solutions. In lines 5-6, the system 10 identifies the lowest reduced cost hypothesis g*, and the triplet constraint that is most violated c*. In lines 7-10, the system 10 adds g* to Ĝ if g* has negative reduced cost, and sets “did_augment” to true, meaning that optimization should continue after this iteration of the loop over lines 2-15. In lines 11-14, if c* corresponds to a violated primal constraint, the system 10 add c* to Ĉ, and sets “did_augment” to true, meaning that optimization should continue after this iteration of the loop over lines 2-15. In line 16, the system 10 solves set packing using only Ĝ. If the LP relaxation is tight in the last iteration of lines 2-15, then the system 10 uses the γ provided during that iteration. In line 17, the system 10 returns the solution γ.

Intelligent schedules can be employed over the operations (e.g., solve the restricted master problem, augment Ĝ and augment Ĉ. For example, multiple elements can be added to Ĝ, and or Ĉ after each time the restricted master problem is solved. Alternatively, the system can only augment Ĉ when no negative reduced cost elements exist to be added to Ĝ.

Returning to FIG. 15, in step 136, the system 10 solves the pricing problem while modifying the structure of the pricing problem. For many problem domains, the system 10 can solve the pricing problem by adding the triples to optimization. One such example is the case of multi-cell instance segmentation. The corresponding pricing problem conditioned on the anchor d* is expressed in Equations 38 and 39, below. The system 10 uses the term z_{c}∈{0, 1} to denote the decision associated with triplet c for all c∈Ĉ. Here z_{c}=1 if two or more members in triplet c are included in the cell.

$$\begin{matrix}{min}_{{{x}_{d} ∈ \{ 0 , 1 \}}_{{{x}_{d} = 0 ∀ d ∉ {𝒟}_{{d}^{*}}}_{{{y}_{{d}_{1} {d}_{2} \geq 0}}_{{z}_{c} \geq 0}}}} {θ}^{0} + {\sum }_{d ∈ 𝒟} ( {θ}_{d}^{1} + {λ}_{d} ) {x}_{d} + {\sum }_{{d}_{1} {d}_{2} ∈ 𝒟} {θ}_{{d}_{1} {d}_{2}}^{2} {y}_{{d}_{1} {d}_{2}} + {\sum }_{c ∈ 𝒞} {ψ}_{c} {z}_{z} & Equation 38 \\ {y}_{{d}_{1} {d}_{2}} \leq {x}_{{d}_{1}} ∀ {d}_{1} , {d}_{2} ∈ 𝒟 \\ {y}_{{d}_{1} {d}_{2}} \leq {x}_{{d}_{2}} ∀ {d}_{1} , {d}_{2} ∈ 𝒟 \\ - {z}_{c} + {x}_{{d}_{3}} + {x}_{{d}_{4}} \leq 1 ∀ c ∈ 𝒞 , [ {d}_{3} ∈ c ] , [ {d}_{4} ∈ c ] , {d}_{3} \neq {d}_{4} & Equation 39\end{matrix}$$

It is noted that that z_{c} is described entirely by x and is set to the smallest possible value at optimality since ψₛ is non-negative. Thus, the system 10 does not require z_{c} to be integer since integrality of z is assured given that x is integral.

In step 138, the system solves the pricing problem without modifying the structure of the pricing problem. Specifically, the system 10 finds negative reduced cost primal variables, given the dual solution λ, ψ where ψ cannot be directly considered, when using a specialized solver for pricing. First, the system 10 denotes the reduced cost of a hypothesis g as V (Γ, λ, ψ, g). The reduced cost of the lowest reduced cost hypothesis is denoted as as V*(Γ, λ, ψ). V (Γ, λ, ψ, g), V*(Γ, λ, ψ) are expressed in Equation 40, below:

$$V ( Γ , λ , ψ , g ) = {Γ}_{g} + {\sum }_{d ∈ 𝒟} {λ}_{d} {G}_{d g} + {\sum }_{c ∈ \hat{𝒞}} {ψ}_{c} {C}_{c g} \\ {V}^{*} ( Γ , λ , ψ ) = {min}_{g ∈ 𝒢} V ( Γ , λ , ψ , g ) \qquad Equation 40$$

The system 10 applies a specialized solver and ignores the triplet term Σ_{c∈Ĉ}ψ_{c}C_{cg}, providing a lower bound. Specifically, the system 10 can use a branch and bound (“B&B”) approach. The set of branches in a B&B tree is denoted B. Each branch b∈B is defined by two sets D_{b+}, and D_{b-}. These correspond to observations that must be included in the hypothesis and those that must not be included in the hypothesis respectively. The set of all hypotheses that are consistent with both D_{b+} and D_{b-} is expressed as G_{b±}. The bounding and branching operators will be discussed in further detail below. The initial branch b is defined by D_{b+}=D_{b-}={ }.

Regarding the bounding operator, pricing ignoring the 0 terms is referred to as the independent pricing problem. Term V^{b}(Γ, λ, ψ) denotes a value of the lowest reduced cost over columns in G_{b±}. The system 10 computes a lower-bound for this value, denoted V^{b}_{lb} by independently optimizing the independent pricing program and the triplet penalty, as expressed below in Equation 41:

$${V}^{b} ( Γ , λ , ψ ) = {min}_{g ∈ {𝒢}_{b \pm }} V ( Γ , λ , ψ , g ) = {min}_{g ∈ {𝒢}_{b \pm }} {Γ}_{g} + {\sum }_{d ∈ 𝒟} {λ}_{d} {G}_{d g} + {\sum }_{c ∈ \hat{C}} {ψ}_{c} {C}_{cg} \geq {min}_{g ∈ {𝒢}_{b \pm }} {Γ}_{g} + {\sum }_{d ∈ 𝒟} {λ}_{d} {G}_{dg} + {min}_{g ∈ {𝒢}_{b \pm }} {\sum }_{c ∈ \hat{C}} {ψ}_{c} {C}_{cg} \geq {min}_{g ∈ {𝒢}_{b \pm }} {Γ}_{g} + {\sum }_{d ∈ 𝒟} {λ}_{d} {G}_{d g} + {\sum }_{c ∈ \hat{C}} {ψ}_{c} [ {\sum }_{d ∈ D} [ d ∈ c ] [ d ∈ {D}_{b +} ] \geq 2 ] = {V}_{l b}^{b} ( Γ , λ , ψ ) \qquad Equation 41$$

The system 10 can compute min_{g∈Gb±}Γ_{g}+Σ_{d∈D} λ_{d}G_{dg} for applications in multi-object tracking and multi-person pose estimation. In multi-person tracking, when performing dynamic programming, the system 10 enforces that g∈g_{b±} as follows: 1) Enforcing D_{b-}: For each subtrack s that includes a d∈D_{b-}, the system sets the corresponding θₛ value of ∞; and 2) Enforcing D_{b+}: For each subtrack s that includes a detection co-occurring in time with any d∈D_{b-} (other than d), the system sets the θₛ to ∞. Similarly, the system 10 does not consider starting a track after the occurrence of the first member of D_{b+} in time. After completing the dynamic program generating tracks, the system 10 sets the reduced cost to ∞ for any track terminating prior to the point in time of the last member of D_{b+}. In multi-person pose estimation, the system 10 forces detections D_{b}+, D_{b-} to be active/inactive respectively when generating a person.

Branch operation will now be discussed. The system 10 expresses an upper bound on V^{b}(Γ, λ, ψ) as V^{b}_{ub}(Γ, λ, ψ). The system 10 constructs this by adding in the active ψ terms ignored when constructing V^{b}_{lb} (Γ, λ, ψ). Setting g_{b}=arg min_{g∈Gb±}Γ_{g}+Σ_{d∈D} λ_{d}G_{dg} yields Equation 42, below:

$${V}_{u b}^{b} ( Γ , λ , ψ ) = {Γ}_{{g}_{b}} + {\sum }_{d ∈ 𝒟} {λ}_{d} {G}_{d {g}_{b}} + {\sum }_{c ∈ \hat{C}} {ψ}_{c} {C}_{{cg}_{b}} \qquad Equation 42$$

The largest triplet term ψ_{c} that is included in V^{b}_{ub}(Γ, λ, ψ) but not V^{b}_{lb}(Γ, λ, ψ) is expressed in Equation 43, below:

$${c}^{*} ← ar g {max}_{c ∈ \hat{C}} {ψ}_{c} {C}_{{cg}_{b}} [ {\sum }_{d ∈ 𝒟} [ d ∈ c ] [ d ∈ {𝒟}_{b +} ] < 2 ] \qquad Equation 43$$

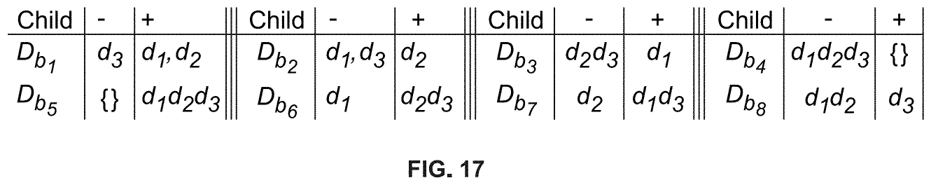

The system 10 generates eight new branches for each of the eight different ways of splitting the observations in the triplet term corresponding to c* between the include (+) and exclude (−) sets. FIG. 17 is a table showing splits enumerated for a triplet of observations c*={d1, d2, d3}. Specifically, The system 10 enumerates the eight sets each describing one way of partitioning the three observations d1, d2, d3 between the include (+) and exclude (−) sets for the children of branch b. For example, branch D_{b8} excludes d₁ and d₂ but includes d₃ so D_{b8-}=[D_{b}−∪d₁∪d₂] and the set D_{b8}+=[D_{b}+∪d₃].

It is noted that not all child nodes need be created as some are guaranteed to be infeasible if some observations in c* already belongs to D_{b-} or D_{b+}. For example, let us assume that c*=d₁, d₂, d₃. If d₁∈D_{b+}, then the child nodes D_{b2}, D_{b4}, D_{b6} and D_{b8} will all be infeasible because d₁ belongs to both + and − decisions. Furthermore, if d₃∈D_{b-}, then all nodes D_{b5}, D_{b6}, D_{b7} and D_{b8} are infeasible. Thus only the nodes D_{b1} and D_{b3} are feasible and g_{b} remains an optimal solution for D_{b1}. Note that the branch operator is not applied if ψ_{c}*=0.

The following section discussed upper bounds on the Lagrange multipliers λ, called dual optimal inequalities (“DOI”), which do not remove all dual optimal solutions. The system 10 using of DOI decreases the search space that column generation needs to explore, thus decreasing the number of iterations of pricing required. For various applications including cutting stock, and image segmentation, DOI are used to dramatically decrease optimization time without sacrificing optimality.

Regarding basic dual optimal inequalities, it is noted that at any given iteration of column generation, the optimal solution to the primal LP relaxation need not lie in the polyhedron of Ĝ. If limited to producing a primal solution over Ĝ, it is useful to allow Σ_{g∈G}G_{dg}γ_{g} to exceed one for some d∈D.

The system 10 uses a slack term ξ_{d}≥0 that tracks the presence of any observations included more than once and prevents them from contributing to the objective when the corresponding contribution is negative. Specifically, the system 10 offsets the cost for “over-including” an observation with a cost that at least compensates and likely overcompensates. It is noted that removal of a detection d from a hypothesis increases the cost of a hypothesis by no more than Ξ_{d} for each d, where Ξ_{d} is expressed by Equation 44, and the expanded MWSP objective and its dual LP relaxation are expressed by Equation 45, both below:

$$\begin{matrix} {Ξ}_{\overline{d}} \geq {max}_{\begin{matrix}g ∈ 𝒢 \\ \overline{g} ∈ 𝒢 \\ {G}_{d g} = {G}_{d \overline{g}} [ d \neq \overline{d} ] ∀ d ∈ 𝒟\end{matrix}} max ( 0 , {Γ}_{g} - {Γ}_{\overline{g}} ) & Equation 44 \\ {min}_{\begin{matrix}{γ}_{g} \geq 0 \\ {ξ}_{d} \geq 0 \\ {\sum }_{g ∈ 𝒢} {G}_{d g} {γ}_{g} - {ξ}_{d} \leq 1\end{matrix}} {\sum }_{g ∈ 𝒢} {Γ}_{g} {γ}_{g} + {\sum }_{d ∈ 𝒟} {Ξ}_{d} {ξ}_{d} = {max}_{\begin{matrix}{Ξ}_{d} \geq {λ}_{d} \geq 0 \\ {Γ}_{g} + {\sum }_{d ∈ 𝒟} {G}_{d g} {λ}_{d} \geq 0\end{matrix}} - {\sum }_{d ∈ 𝒟} {λ}_{d} & Equation 45\end{matrix}$$

It is noted that the dual relaxation bounds λ by Ξ from above. These bounds are called dual optimal inequalities DOIs. To ensure that the DOIs are not active at termination of column generation, the system 10 offsets Ξ with a tiny positive constant.

It should be understood that the use of the DOI does not cut off all dual optimal solutions when Ĝ=G. Specifically, the system 10 can map any solution γ, ξ, where ξ is optimal given γ to a feasible solution γ̅, ξ̅ where ξ̅ is a zero vector, such that the cost of the y, is less than or equal to that of y, To achieve this, the system 10 iterates over d, then convert hypotheses including d to those not including d proportional to Σ_{id}./(1+ξ_{d}). The system 10 defines g^{-d} in Equation 46, below, for all pairs \hat{d}∈D, g∈G:

G_{dg-\hat{d}}=G_{dg}[\hat{d}≠d] Equation 46

The system 10 converts γ, ξ to γ̅, ϵ̅ by iterating over d, then over g∈G such that G_{dg}=1 and γ_{g}>0, and then applying an update expressed in Equation 47, below:

α←min(γ_{g},ξ_{d})

γ_{g}←γ_{g}−α

γ_{g}−d←γ_{g}−d+α

ξ_{d}←ξ_{d}−α Equation 47

In Equation 47, α is the magnitude of the update to the terms γ_{g}, γ_{g}−d, ξ_{d}. The change in the objective using Equation 47 is expressed in Equation 48, below:

α(−Ξ_{d}+Γ_{g}^{-d}−Γ_{g}) Equation 48

Since Ξ_{d}≥Γ_{g\hat{ }(-d)}−Γ_{g} by definition, and a is positive, then the total change in Equation 48 is non-negative. Thus, there exists an optimal primal solution in which ξ is the zero vector. Therefore, the use of DOI does no remove all dual optimal solutions.

This section discusses dual optimal inequalities that are not looser that those discussed above. The system 10 uses Ĝ to denote the set of hypotheses which are subsets of hypotheses in Ĝ. Thus, at any given point in column generation, the system 10 binds λ_{d} as in Equation 44, above, except replacing optimization over G with Ĝ*, which is expressed in Equation 49, below:

$${Ξ}_{\overline{d}} \geq {max}_{\begin{matrix}g ∈ \overline{𝒢} * \\ \overline{g} ∈ \hat{𝒢} * \\ {G}_{d g} = {G}_{d \overline{g}} [ d \neq \overline{d} ] ∀ d ∈ 𝒟\end{matrix}} max ( 0 , {Γ}_{g} - {Γ}_{\overline{g}} ) \qquad Equation 49$$

It is noted that bounds in Equation 49 are not greater than Equation 44 and may increase when elements are added to Ĝ. The DOI in Equations 44 and 49 are referred to as invariant and varying DOI, respectively.

The following section discusses generating a valid DOI for multi-person pose estimation, multi-cell segmentation, and multi-person tracking. Regarding multi-person pose estimation and an invariant DOI, the removal of a detection d from a pose removes from the cost the associated and any active pairwise terms, θ²_{dd1}, θ²_{d1d}. Similarly, if d is the only detection in a pose, then the θ⁰ term is also removed. The system 10 upper bounds the sum of these three terms by considering only the positive valued terms and θ¹_{d}. If this sum is negative, the system 10 sets the upper bound d to zero, since λ is non-negative by definition. The system express Ξ_{d} using Equation 50, below:

$${Ξ}_{d} = - min ( 0 , min ( 0 , {θ}_{0}^{-} ) + {θ}_{d} + {\sum }_{{d}_{1} ∈ 𝒟} min ( 0 , {θ}_{{dd}_{1}} + {θ}_{{d}_{1} d} ) ) \qquad Equation 50$$

Regarding multi-person pose estimation and an invariant DOI, the system 10 produces Ξ_{d} by using the same approach as in Equation 50, except that the system 10 only considers pairwise terms that could be removed when replacing members of Ĝ* with other members of Ĝ*, as expressed below in Equation 51:

$${Ξ}_{d} = - min ( 0 , min ( 0 , {θ}_{0}^{-} ) - {θ}_{d} - {min}_{\begin{matrix}g ∈ \hat{𝒢} \\ {G}_{dg} = 1\end{matrix}} {\sum }_{{d}_{1} ∈ 𝒟} min ( 0 , {θ}_{{dd}_{1}} + {θ}_{{d}_{1} d} ) ) \qquad Equation 51$$

The DOI for multi-cell segmentation are identical to the DOI for multi-person pose estimation Regarding multi-person tracking, the system 10 consider the production of Ξ_{d} for tracking. The system 10, rather than producing a single track when removing an element d, splits the track into two separate tracks, where d defines the boundary, and itself is removed. The removal of d causes the removal of the costs of all subtracks including d. This procedure will produce a track if d is a middle element in the track. Similarly, if d is in every subtrack, then this procedure removes a track.

For invariant DOI, the system denotes δ_{s,d,k} to be the lowest total cost sequence of subtracks each including d (e.g., δ_{s,d,K}=θₛ), where the last subtrack in the sequence is s and d is in position k, as expressed in Equation 52, and using δ to express Ξ_{d} is shown in Equation 53, both below:

$$\begin{matrix}{δ}_{s , d , k} = {θ}_{s} + min ( 0 , {min}_{\hat{s} ∈ \{ ⇒ s \}} {δ}_{\hat{s} , d , k + 1} ) for [ 1 \leq k < K ] & Equation 52 \\ {Ξ}_{d} = - min ( 0 , - \vert {θ}^{0} \vert + {min}_{\begin{matrix}s , k \\ {s}_{k} = d\end{matrix}} {δ}_{s , d , k} & Equation 53\end{matrix}$$

In Equation 53, the system adds the absolute value of θ⁰ since the removal of all subtracks including d may create two tracks from one or remove a track without replacing it. Further, In Equation 53, all possible sequences of subtracks that contain d are considered. However, the system 10 in regards to the varying DOI need only consider the sequences of subtracks in tracks in Ĝ. As such, the system denotes δ_{gs,d,k} be the lowest total cost sequence of subtracks of g each including d, where the last subtrack in the sequence is s and d is in position k, as expressed in Equations 54-56, below:

$$\begin{matrix} {δ}_{s , d , K}^{g} = {θ}_{s} ∀ s s . t . {T}_{sg} = 1 & Equation 54 \\ {δ}_{s , d , k}^{g} = {θ}_{s} + min ( 0 , {min}_{\hat{s} ∈ \{ ⇒ s \} , {T}_{\hat{s} g} = 1} {δ}_{\hat{s} , d , k + 1} ) for [ 1 \leq k < K ] & Equation 55 \\ {Ξ}_{d} = - min ( 0 , - \vert {θ}^{0} \vert + {min}_{\begin{matrix}g ∈ \hat{𝒢} \\ {G}_{dg} = 1\end{matrix}} {min}_{\begin{matrix}s , k \\ {s}_{k} = d\end{matrix}} {δ}_{s , d , k}^{g} & Equation 56\end{matrix}$$

The following section discusses the system 10 generating a lower bound on the LP relaxation at termination of column generation. Given any fixed set Ĝ, solving the restricted master problem (RMP) does not necessarily provide a lower bound on the ILP over G. The system 10 can generate anytime lower bounds by adding to the LP objective the lowest reduced costs of terms generated during pricing

As discussed above, each observation can be assigned to at most one hypothesis. The system generates a lower bound using Equation 57, below, given any non-negative λ provided by the RMP:

$$- {\sum }_{d ∈ 𝒟} {λ}_{d} - {\sum }_{c ∈ C} {ψ}_{c} - \vert 𝒟 \vert {min}_{g ∈ 𝒢} ( 0 , {Γ}_{g} + {\sum }_{d ∈ 𝒟} {G}_{dg} {λ}_{d} + {\sum }_{c ∈ C} {C}_{cg} {ψ}_{c} ) \qquad Equation 57$$

It is noted that minimization in Equation 57 is the pricing problem called at each iteration of column generation. The bound in Equation 57 can be tightened using an application specific analysis. For example, the corresponding lower bound for multi-person tracking, adds to the RMP objective the following: a sum of the negative valued, reduced costs for the lowest reduced cost track terminating at each detection, expressed below in Equation 58, where there are no triplets:

$$- {\sum }_{d ∈ 𝒟} {λ}_{d} - {\sum }_{d ∈ 𝒟} {min}_{\begin{matrix}g ∈ 𝒢 \\ d = [ last detection in g ]\end{matrix}} min ( 0 , {Γ}_{g} + {\sum }_{d ∈ 𝒟} {λ}_{d} {G}_{dg} ) \qquad Equation 58$$

It is further noted that Equation 57 provides a lower bound on the optimal packing. Specifically, rewriting the optimization incorporating that the number of hypothesis selected by any packing is bounded by the number of observations, since every selected hypothesis must contain at least one observation, yields Equation 59, below:

$${min}_{\begin{matrix}{γ}_{g} \geq 0 \\ {\sum }_{g ∈ 𝒢} {γ}_{g} \leq \vert 𝒟 \vert \\ \begin{matrix}{\sum }_{g ∈ 𝒢} {G}_{dg} {γ}_{g} \leq 1 & ∀ d ∈ 𝒟 \\ {\sum }_{g ∈ 𝒢} {C}_{cg} {γ}_{g} \leq 1 & ∀ c ∈ C\end{matrix}\end{matrix}} {\sum }_{g ∈ 𝒢} {Γ}_{g} {γ}_{g} \qquad Equation 59$$

Dualizing the packing constraint and the subset-row inequalities, but retaining in the minimization, the constraint that no more than D hypothesis are selected, as expressed below where Equation 59 is equal to Equation 60:

$${min}_{\begin{matrix}{γ}_{g} \geq 0 \\ {\sum }_{g ∈ 𝒢} {γ}_{g} \leq \vert 𝒟 \vert\end{matrix}} {max}_{\begin{matrix}{λ}_{d} \geq 0 \\ {ψ}_{c} \geq 0\end{matrix}} {\sum }_{g ∈ 𝒢} {Γ}_{g} {γ}_{g} + {\sum }_{d ∈ 𝒟} {λ}_{d} ( - 1 + {\sum }_{g ∈ 𝒢} {G}_{dg} {γ}_{g} ) + {\sum }_{c ∈ C} {ψ}_{c} ( - 1 + {\sum }_{g ∈ 𝒢} {C}_{cg} {γ}_{g} ) \qquad Equation 60$$

The system 10 then relaxes the constraint the λ, ψ is optimal, and reorders terms by γ, which yields Equation 60 being greater of equal to Equation 61, below:

$$- {\sum }_{d ∈ 𝒟} {λ}_{d} - {\sum }_{c ∈ C} - {ψ}_{c} + {min}_{\begin{matrix}{γ}_{g} \geq 0 \\ {\sum }_{g ∈ 𝒢} {γ}_{g} \leq \vert 𝒟 \vert\end{matrix}} {\sum }_{g ∈ 𝒢} {γ}_{g} ( {Γ}_{g} + {\sum }_{d ∈ 𝒟} {G}_{dg} {λ}_{d} + {\sum }_{c ∈ C} {C}_{cg} {ψ}_{c} ) \qquad Equation 61$$

It is noted that the inner minimization selects the lowest reduced cost solution |D| times if a negative reduced cost hypothesis exists and otherwise has zero value. Thus, Equation 61 is equal to Equation 62, below:

$$- {\sum }_{d ∈ 𝒟} {λ}_{d} - {\sum }_{c ∈ C} - {ψ}_{c} + \vert 𝒟 \vert min ( 0 , {min}_{g ∈ 𝒢} {Γ}_{g} + {\sum }_{d ∈ 𝒟} {G}_{dg} {λ}_{d} + {\sum }_{c ∈ C} {C}_{cg} {ψ}_{c} ) \qquad Equation 62$$

Testing and analysis of the above systems and methods will now be discussed in greater detail. Specifically, computational results will be discussed on the three applications discussed above, multi-person tracking, multi-person pose estimation, multi-cell segmentation. The system of the present disclosure used a part of MOT 2015 training dataset, to train and evaluate multi-person tracking in video. The system 10 further used a structured support vector machine (“SVM”) based learning approach as the mechanism to produce cost terms. To generate the set of detections D, the system 10 used the raw detector output provided by the MOT dataset. The system 10 trained models with varying subtrack length (K=2, 3, 4), and allowed for occlusion up to three frames.

In the problem instance for testing, there are 71 frames and 322 detections in the video. The numbers of subtracks present are 1,068, 3,633 and 13,090 for K=2, 3, 4 respectively. For K=2, 48.5% “Multiple Object Tracking Accuracy”, 11 identity switches, and 9 track fragments were observed, which can be expressed as (48.5,11,9). However, when setting K=3, 4 the performance is (49,10,7) and (49.9, 9, 7) respectively. Thus, increasing subtrack length provides noticeable improvements over all metrics.

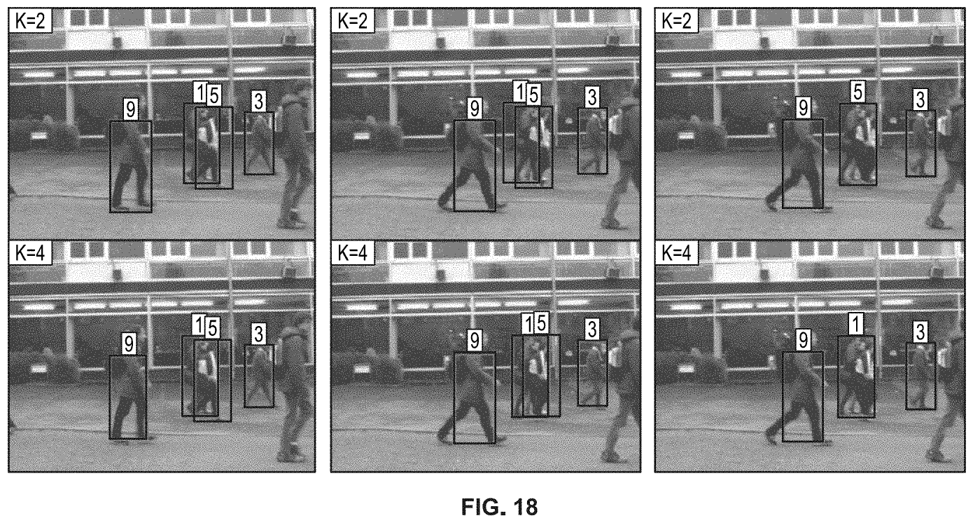

FIG. 18 is a set of images showing these results. Specifically, FIG. 18 illustrates a qualitative example of improvement as a result of increasing subtrack length. The first and second row describe tracks outputted when K=2 and K=4 respectively. It is noted that for K=2, track one changes identity to track five, while with K=4 the identity of track one does not change.

Each time the present system solves the pricing problem, the present system adds to Ĝ, the lowest reduced cost track terminating at each detection, excluding those with non-negative reduced cost. As discussed above, the dynamic programming structure of the pricing problem facilitates this computation.

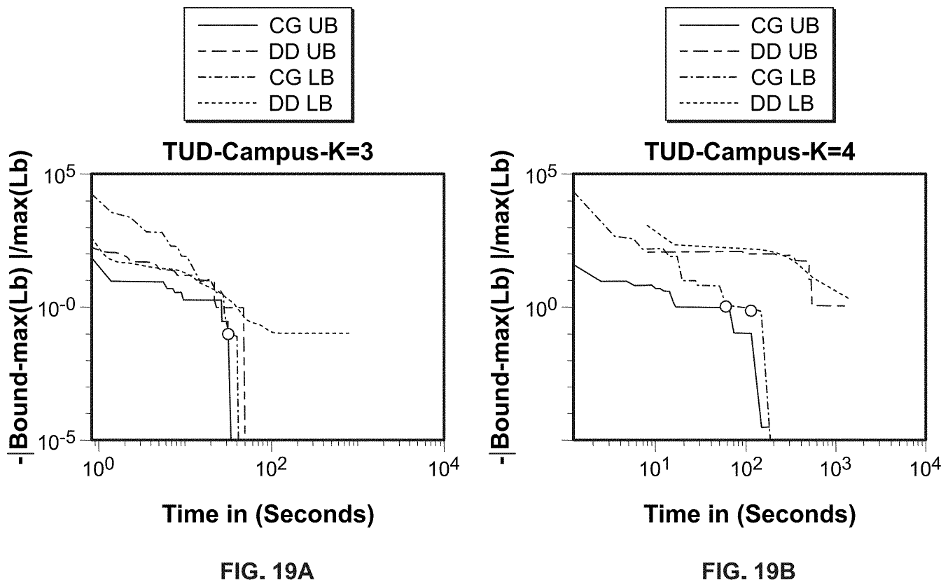

FIGS. 19A-B are graphs showing a comparison of timing/cost performance of the present disclosure with a baseline dual decomposition approach. Specifically, the problem instances are associated with a loose lower bound, which are tightened using triplets. When triplets are added to the restricted master problem, the lower bound becomes tight, on these problem instances. FIGS. 19A-B shows the convergence of upper/lower bounds as a function of time. The present system plots the gap (absolute value of the difference) between the bounds, and the final lower bound as a function of time. The present system then normalizes all plotted values, by dividing each by the value of the maximum lower bound times −1. Each time that a triplet is added with a blue dot is initiated don the lower bound plot. The present system compares column generation (denoted as “CG”), against the dual decomposition approach (denoted as “DD”). CG achieves tight upper and lower bounds at termination. Pricing in CG is achieved using earlier version of pricing of when triples are present. In this version, it is not required that tracks to pass through detections in D_{b+} when computing V^{b}_{lb}.

The testing and analysis in this section used the following enhancements to column generation: anytime lower bounds and subset-row inequalities. However dual optimal inequalities are not employed. The present system evaluated the above discussed methods on the MPII-multi-person validation set, which consists of 418 images. The present system used the cost terms θ¹, θ² with the following modifications. First, γ_{d1d2}=oc for each pair of unique neck detections d₁, d₂. This accelerates optimization since the present system need not explore an entire power set of neck detections during pricing. Second, the present system construct D^{r} as follows. The system provides a probability that each detection d is associated with each body part r denoted p_{dr}. For each detection d, the system assigns it to the set V^{r} that maximizes this probability. This assignment corresponds to the following optimization arg maxᵣ p_{dr} for a given d∈V. Third, the system sets θ⁰ to a single value for the entire data set. Lastly, the system limits a size of S^{r} to 50,000 for each r∈R. The system constructs S^{r} as follows: the system iterates over integer k=[0, 1, 2, . . . |V^{r}|], then adds to S^{r} the group of configurations containing exactly k detections in V^{r}. If adding a group would have S^{r} exceed 50,000, then the system does not add the group and terminate construction of S^{r}.

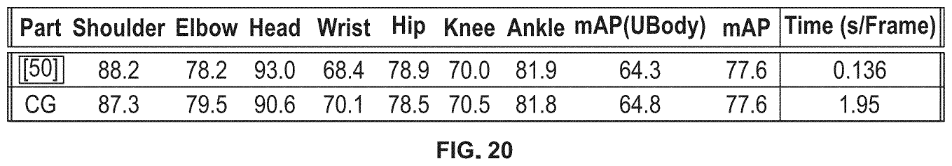

The set packing relaxation, is tight in over 99% of problem instances, and in the remaining cases the gap between the lower and upper bounds is less than 1.5% of the LP objective. The present system produces an integral solution, when the set packing LP is loose by solving the set packing ILP over Ĝ. FIG. 20 shows a table comparing column generation against a prior art heuristic optimization procedure in terms of the accuracy (average precision) on standard computer vision benchmarks. Running times are measured on an Intel i7-6700k quad-core CPU. The present system outperforms the prior art procedure to localize body parts, such as wrists and ankles. Optimization time is accelerated by using nested Benders decomposition to accelerate dynamic programming, which provides up to 500 times speedup.

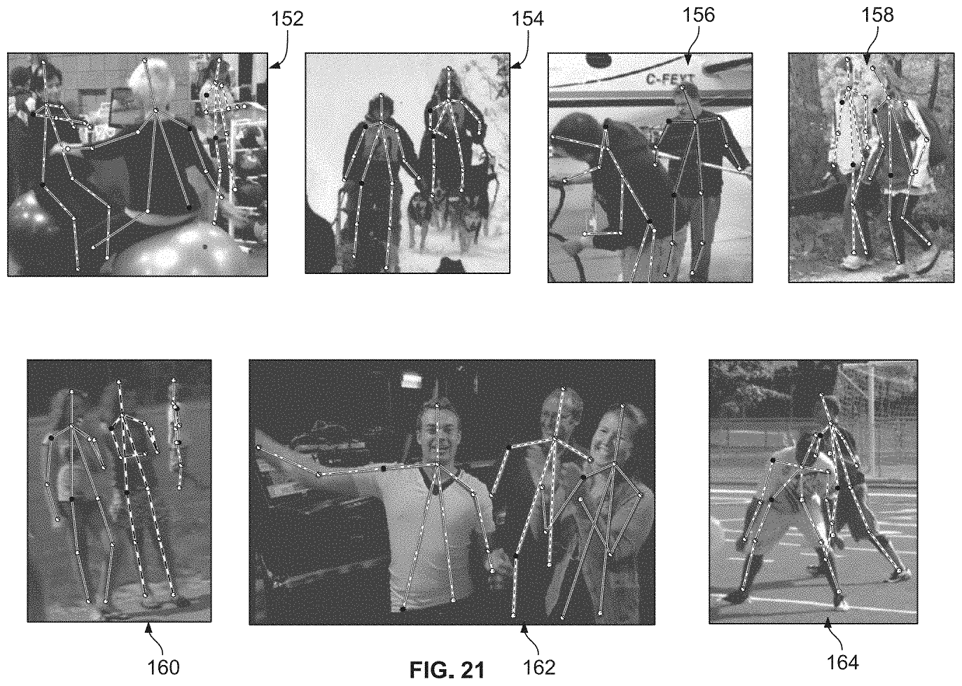

FIG. 21 is a set of images showing sample outputs 152, 154, 156, 158, 160, 162, 164 of the system of the present disclosure. For each person, the present system averages a location of the detections corresponding to each of the body parts to produce a corresponding colored dot, denoting the position of the body part.

The following section will discuss the performance improvements provided by the system of the present disclosure using DOI (dual optimal inequalities). To establish the value of DOI, the present system decouples the value provided by DOI from that provided by varying the solver. The solver is defined by an LP toolbox (e.g., linprog, CPLEX, Gurobi), options for the toolbox such as algorithm used (interior point, simplex, etc.) and the computer used. Decoupling the value added by DOI from that added by the solver is important since some solvers work dramatically better than others and that DOI provides different speedups depending on the solver.

This difference in performance is accounted for by the number of iterations of column generation. Different solvers provide different dual optimal solutions. In column generation, the space of dual optimal solutions rarely consists of a single point but a space of such points. Using dual optimal solutions that are well centered allows column generation achieve faster convergence. Well centered solutions are solutions that have low L2 norm, meaning that the mass of the dual variables is not concentrated in a small number of variables.

Regarding a well centered solution, considering a step of pricing, using a poorly centered dual solution, in which only a small number of observations D⁻ have non-zero dual value. The hypotheses produced in pricing, will not include D⁻, but will be otherwise inclined to produce similar columns to those produced in the first iteration of column generation, where dual variables have value zero. Thus, the use of poorly centered solutions tends to lead to little progress in column generation.

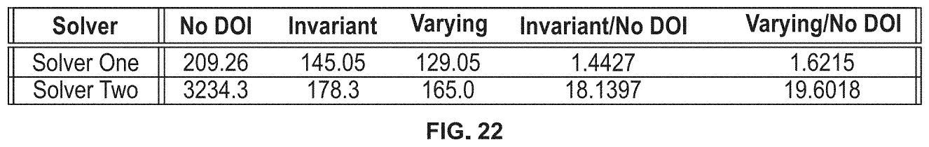

In the present system, the time spent performing pricing vastly exceeds that for solving the RMP (restricted master problem). Thus, using a faster toolbox, such as CPLEX or Gurobi to solve the RMP adds little value if the resultant dual solution is not well centered. The solvers used for testing are as follows. Solver one: MAT-LAB 2016 linprog solver with default settings. Solver two: MATLAB 2017 with the interior point solver on a workstation. FIG. 22 is a table showing the results between solver one and solver 2. Specifically, FIG. 22 is a table showing a comparison in the total time in seconds, and comparative speedup (over no DOI) using DOI on the two different solvers. The first three columns describes the total time needed to solve the LP relaxation for column generation using no DOI, invariant DOI, and the varying DOI respectively. In the final two column, FIG. 22 shows the factor speed up achieved by using invariant and varying DOI over not using DOI. This is done by dividing the content in columns two and three by the corresponding values in column one.

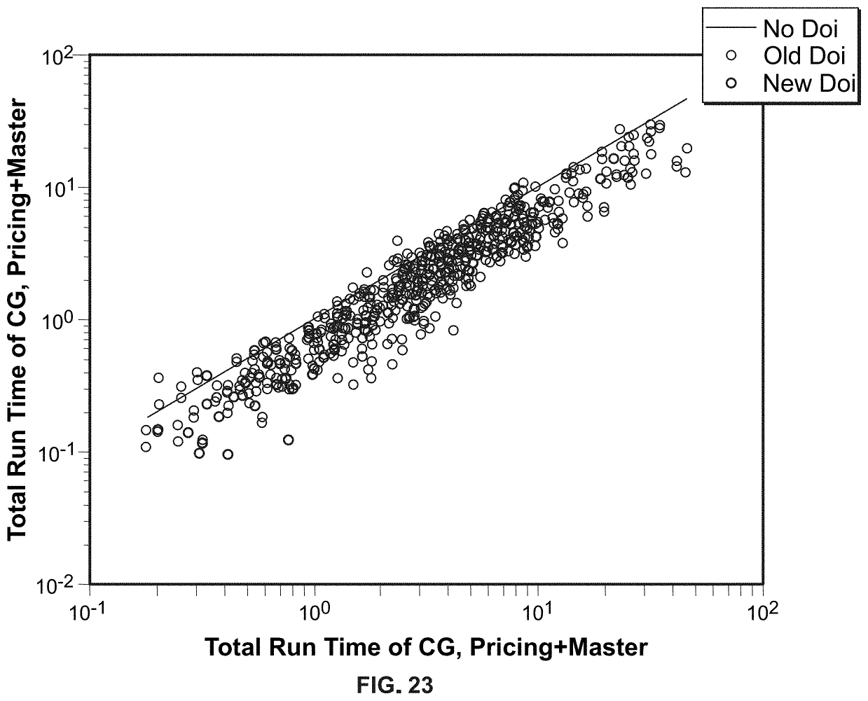

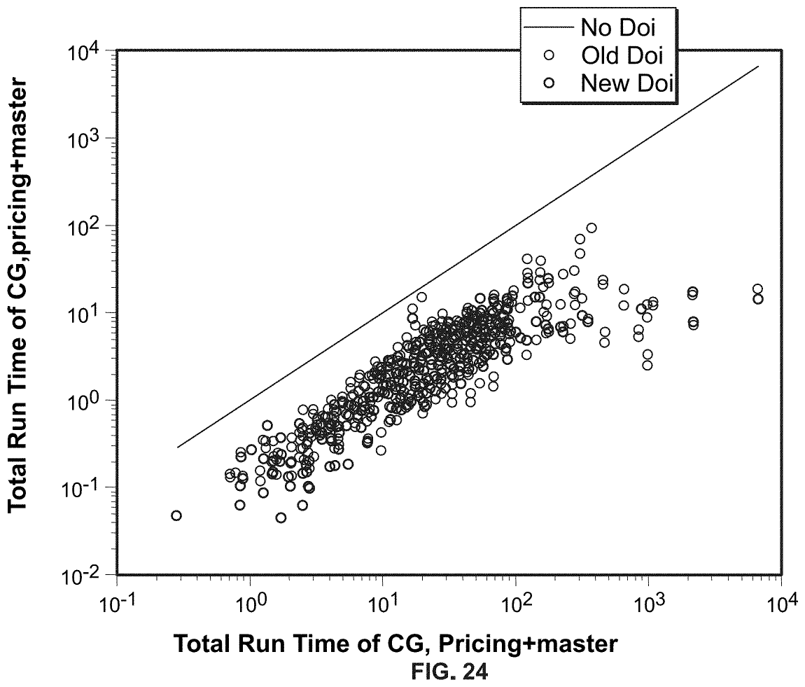

FIGS. 23-24 are scatter plots showing the time consumed using DOI for each solver. Specifically, FIGS. 23-24 show the change in total run time when using dual optimal inequalities on two different computers. Each data point corresponds to the time needed to fully optimize the LP relaxation of set packing relative to the time needed when not using dual optimal inequalities. FIG. 23 used a MATALB linprog solver with default settings using a 2014 Apple® Macbook 13 inch computer. FIG. 24 shows a powerful up to date mainframe using Matlab linprog solver using the interior point algorithm.

Testing showed that the DOI, that vary with Ĝ outperform those that are invariant. The use of DOI provides a large speedup to solver two (nearly 20 times speedup) but limited speedup to solver one (only 1.4-1.6 times speedup). Further, solver one is an older computer running an older version of MATLAB than solver two but the timing results of solver one are better than those of solver two for each selection of DOI. This is a consequence of solver one producing well centered solutions, and solver two not. The use of DOI makes solver two perform almost as well as solver one demonstrating the value of DOI when the solver is poorly selected.

The following experiments use the column generation enhancement of anytime lower bounds but not subset-row inequalities. DOI are not used in the experiments. The present system applies column generation for multi-cell segmentation on three different data sets. The problem instances include challenging properties, such as densely packed and touching cells, out-of-focus artifacts, and variations in the shape/size of cells.

To generate cost terms, the present system uses an open source toolbox to train a random forest classifier to discriminate: (1) boundaries of in-focus cells; (2) in-focus cells; (3) out-of-focus cells; and (4) background. For training, the present system used <1% pixels per dataset with generic features e.g. gaussian, lapla-cian, and structured tensor. The output of this random forest classifier are also used to generate superpixels.

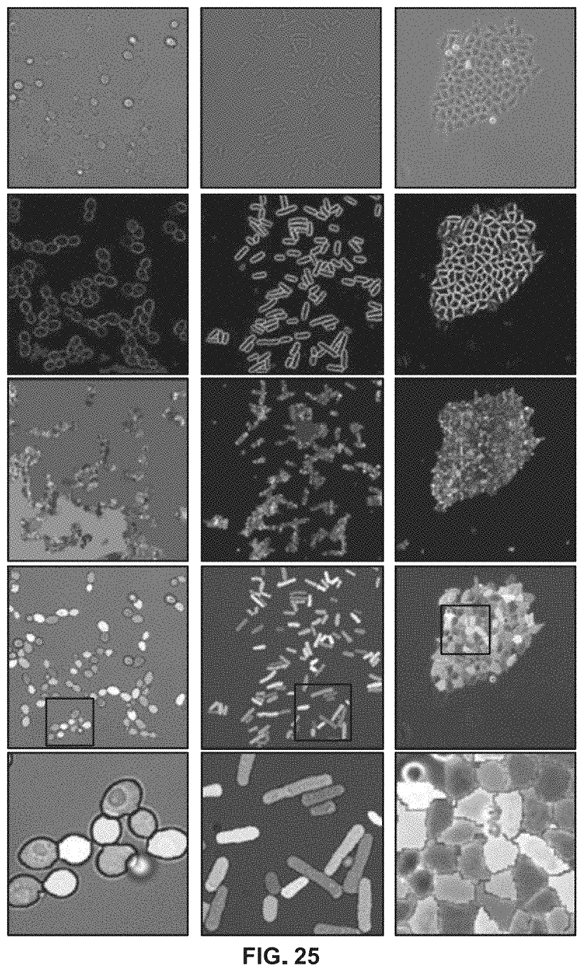

FIG. 25 is an illustration showing an output of the present system. Specifically, FIG. 25 shows example cell segmentation results of datasets one-three (left to right), where the rows (going from top to bottom) original image, cell of interest boundary classifier prediction image, super-pixels, color map of segmentation, and enlarged views of the inset (black square). For dataset two, it is observed that the present system successfully segments the cells in a problem instance, where there are large variations of cell shape/size even in the same image.

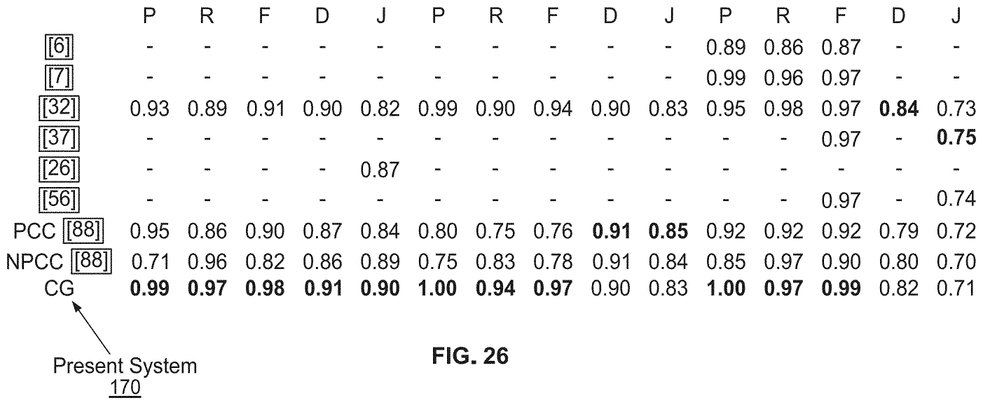

The performance of the system of the present disclosure was compared with prior art systems, in terms of detection (precision, recall and F-score), and segmentation (Dice coefficient and Jaccard index) which are common measures in bio-image analysis. FIG. 26 is a graph showing the results of the comparison between the present system 170, and prior art systems. Evaluation comparison of datasets one-three on precision (P), recall (R), F-score (F), dice coefficient (D) and Jaccard index (J) are reported for the present system 170 and the prior art systems. System [88] uses the algorithms planar correlation clustering (PCC) and non-planar correlation clustering (NPCC). The present system 170 achieves or exceed performances of the prior art systems. Additionally, the present system requires little training data, relative to some prior art systems.

Next, performance of the present system with regard to a gap between the upper and lower bounds is considered. The gaps are normalized by dividing by an absolute value of the lower bound. For the three data sets, the proportion of problem instances that achieve normalized gaps under 0.1 are 99.28%, 80% and 100%, on datasets one, two, and three, respectively.

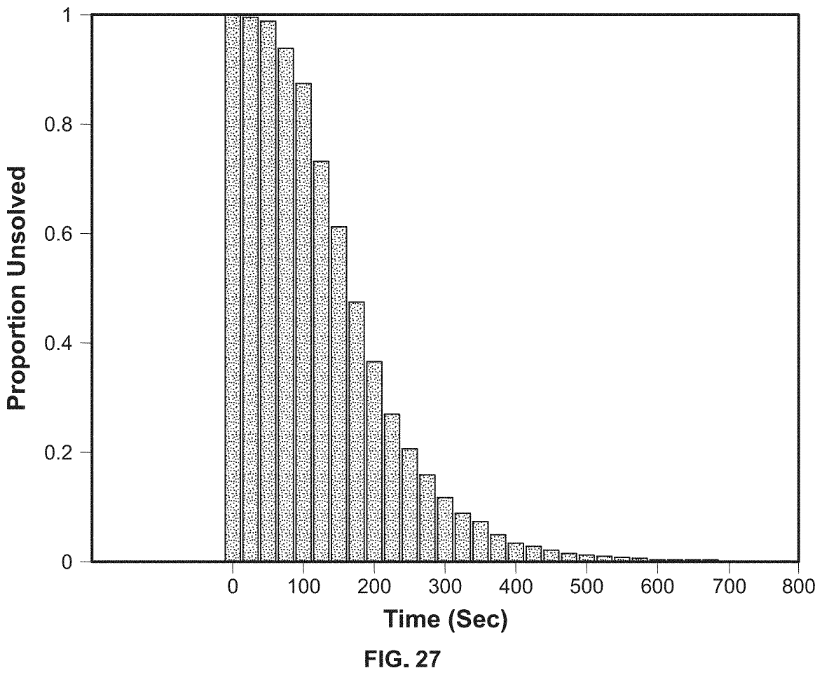

FIG. 27 is a graph showing optimization time for column generation across problem instances in dataset one. Specifically, regarding timing for dataset one, FIG. 27 shows a plotted function of time the proportion of problem instances that take longer than a given amount of time. For over 99% of problem instances, the gap between upper and the lower bound at termination is zero. Thus, the present system is approximately an order of magnitude faster than the combinatorial optimization approaches of prior art systems. Optimization time for column generation is dominated by pricing so parallelization may dramatically accelerate optimization.

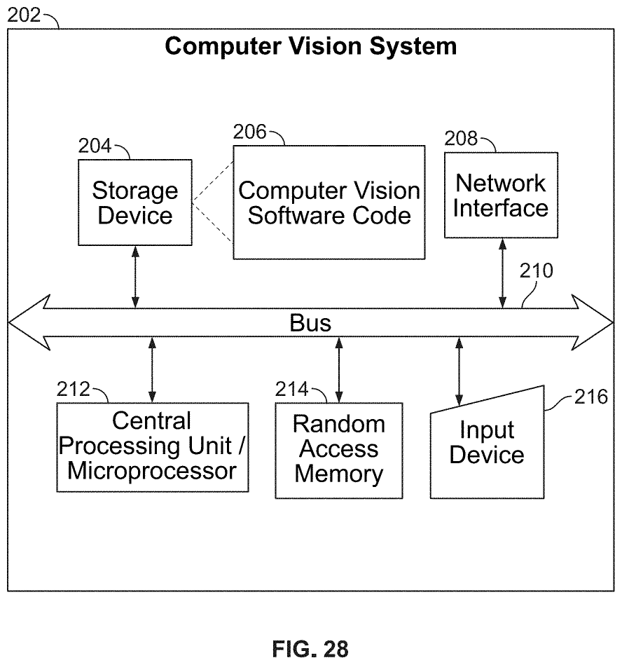

FIG. 28 is a diagram showing a hardware and software components of a computer system 202 on which the system of the present disclosure can be implemented. The computer system 202 can include a storage device 204, computer vision software code 206, a network interface 208, a communications bus 210, a central processing unit (CPU) (microprocessor) 212, a random access memory (RAM) 214, and one or more input devices 216, such as a keyboard, mouse, etc. The server 202 could also include a display (e.g., liquid crystal display (LCD), cathode ray tube (CRT), etc.). The storage device 204 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The computer system 202 could be a networked computer system, a personal computer, a server, a smart phone, tablet computer etc. It is noted that the server 202 need not be a networked server, and indeed, could be a stand-alone computer system.

The functionality provided by the present disclosure could be provided by computer vision software code 206, which could be embodied as computer-readable program code stored on the storage device 204 and executed by the CPU 212 using any suitable, high or low level computing language, such as Python, Java, C, C++, C#, .NET, MATLAB, etc. The network interface 208 could include an Ethernet network interface device, a wireless network interface device, or any other suitable device which permits the server 202 to communicate via the network. The CPU 212 could include any suitable single-core or multiple-core microprocessor of any suitable architecture that is capable of implementing and running the computer vision software code 206 (e.g., Intel processor). The random access memory 214 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by letters patent is set forth in the following claims.

What is claimed is:

1. A system for training a model for a computer system, comprising:
a computer system in communication with a database including raw input data; and
a set packing engine executed by the first computer system, the set packing engine:
processing the raw input data to formulate correlation clustering corresponding to the raw input data as an integer linear program;
processing the correlation clustering to generate an expanded formulation of the correlation clustering;
solving the expanded formulation using a column generation process; and
transmitting training information corresponding to the solved expanded formulation to a model system, the training information assisting the model system in performing computer vision processing on input data to identify output data.

2. The system of claim 1, wherein the set packing engine formulates sequences of subtracks for detecting people in one or more video frames as an integer linear problem.

3. The system of claim 2, wherein the set packing engine defines a set of detections of people in the one or more video frames.

4. The system of claim 3, wherein the set packing engine decomposes track costs in terms of subtrack costs.

5. The system of claim 4, wherein the set packing engine augments sets of subtracks with subtracks padded with empty detections.

6. The system of claim 1, wherein the set packing engine identifies a plurality of body parts in one or more video frames.

7. The system of claim 6, wherein the set packing engine associates pairs of detections with costs associated with a common person.

8. The system of claim 7, wherein the set packing engine aggregates the detections to form representations of people using an integer linear program formulation.

9. The system of claim 1, wherein the set packing engine denotes a set of human body part detections using the raw input data.

10. The system of claim 9, wherein the set packing engine defines a set of people as a power set of the set of human body part detections.

11. The system of claim 10, wherein the set packing engine defines a cost for a person.

12. The system of claim 11, wherein the set packing engine models a person according to a common tree structured model.

13. The system of claim 1, wherein the set packing engine performs dimensionality reduction by partitioning sets of pixels into sets of super-pixels.

14. The system of claim 13, wherein the set packing engine provides a cost for each pair of adjacent super-pixels to be associated with a common cell.

15. The system of claim 14, wherein the set packing engine computes a maximum radius and an area of each cell.

16. The system of claim 1, wherein the set packing engine generates: (i) a set of observations corresponding to a set of superpixels, and (ii) a set of hypotheses corresponding to a set of biological cells.

17. The system of claim 16, wherein the set packing engine defines a radius constraint as a cost.

18. The system of claim 17, wherein the set packing engine denotes an upper bound on an area of a cell and an area of a superpixel.

19. The system of claim 18, wherein the set packing engine defines a volume constraint as a cost.

20. The system of claim 19, wherein the set packing engine describes image-level evidence corresponding to a quality of a cell.

21. The system of claim 1, wherein the set packing engine tightens linear programming relaxation of a minimum weight set packing framework.

22. The system of claim 21, wherein the set packing engine determines whether sub-row inequalities destroy a structure of a pricing problem.

23. The system of claim 22, wherein the set packing engine solves the pricing problem while modifying the structure of the pricing problem.

24. The system of claim 22, wherein the set packing engine solves the pricing problem without modifying the structure of the pricing problem.

25. A method for training a model for a computer system, comprising the steps of:
processing at a processor raw input data to formulate correlation clustering corresponding to the raw input data as an integer linear program;
processing the correlation clustering to generate an expanded formulation of the correlation clustering;
solving the expanded formulation using a column generation process; and
transmitting training information corresponding to the solved expanded formulation to a model system, the training information assisting the model system in performing computer vision processing on input data to identify output data.

26. The method of claim 25, further comprising formulating sequences of subtracks for detecting people in one or more video frames as an integer linear problem.

27. The method of claim 26, further comprising defining a set of detections of people in the one or more video frames.

28. The method of claim 27, further comprising decomposing track costs in terms of subtrack costs.

29. The method of claim 28, further comprising augmenting sets of subtracks with subtracks padded with empty detections.

30. The method of claim 25, further comprising identifying a plurality of body parts in one or more video frames.

31. The method of claim 30, further comprising associating pairs of detections with costs associated with a common person.

32. The method of claim 31, further comprising aggregating the detections to form representations of people using an integer linear program formulation.

33. The method of claim 25, further comprising denoting a set of human body part detections using the raw input data.

34. The method of claim 33, further comprising defining a set of people as a power set of the set of human body part detections.

35. The method of claim 34, further comprising defining a cost for a person.

36. The method of claim 35, further comprising modeling a person according to a common tree structured model.

37. The method of claim 25, further comprising performing dimensionality reduction by partitioning sets of pixels into sets of super-pixels.

38. The method of claim 37, further comprising providing a cost for each pair of adjacent super-pixels to be associated with a common cell.

39. The method of claim 38, further comprising computing a maximum radius and an area of each cell.

40. The method of claim 25, further comprising generating: (i) a set of observations corresponding to a set of superpixels, and (ii) a set of hypotheses corresponding to a set of biological cells.

41. The method of claim 40, further comprising defining a radius constraint as a cost.

42. The method of claim 41, further comprising denoting an upper bound on an area of a cell and an area of a superpixel.

43. The method of claim 42, further comprising defining a volume constraint as a cost.

44. The method of claim 43, further comprising describing image-level evidence corresponding to a quality of a cell.

45. The method of claim 25, further comprising tightening linear programming relaxation of a minimum weight set packing framework.

46. The method of claim 45, further comprising determining whether sub-row inequalities destroy a structure of a pricing problem.

47. The method of claim 46, further comprising solving the pricing problem while modifying the structure of the pricing problem.

48. The method of claim 47, further comprising solving the pricing problem without modifying the structure of the pricing problem.
